(19) United States
(12) Patent Application Publication
(10) Pub. No.: US 2023/0174787 A1
(43) Pub. Date: Jun. 8, 2023

(54) MXENES-METAL AND CERAMIC ASSEMBLIES AND COMPOSITES

(71) Applicant: The Trustees of Indiana University, Bloomington, IN (US)

(72) Inventors: Babak Anasori, Fishers, IN (US); Brian C. Wyatt, JR., Bloomington, IN (US); Srinivasa Kartik Nemani, Indianapolis, IN (US)

(21) Appl. No.: 17/960,968

(22) Filed: Oct. 6, 2022

Related U.S. Application Data
(60) Provisional application No. 63/252,714, filed on Oct. 6, 2021.

(51) Int. Cl. C09C 3/06; C01B 32/921; C09C 3/04; C09C 3/00; C09C 1/64; C09C 1/04; C09C 1/40; C09C 1/28

(52) U.S. Cl. CPC C09C 3/063; C01B 32/921; C09C 3/043; C09C 3/006; C09C 1/642; C09C 1/043; C09C 1/407; C09C 1/28; C01P 2004/80; C01P 2006/90; C01P 2004/61; C01P 2004/03; C01P 2002/72; C01P 2004/24

(57) ABSTRACT

A composite comprising a MXene and a post-transition metal wherein the post-transition metal is at least partially encapsulated by from 1 to 4 layers of the MXene. Methods of making such a composite are also disclosed.

### CROSS-REFERENCE TO RELATED APPLICATION

This application claims priority to U.S. Provisional Patent Application Ser. No. 63/252,714 filed Oct. 6, 2021, the content of which is incorporated by reference herein in its entirety.

### BACKGROUND

Two-dimensional (“2D”) transition metal carbides are known as MXenes, embodiments of which are generally described in U.S. Pat. No. 10,720,644, issued Jul. 21, 2020, the content of which is incorporated by reference herein in its entirety.

### SUMMARY

There is a need for new composites containing MXenes and for new facile methods of producing such composites.

According to an embodiment, a composite comprises a MXene having a general formula of Mₙ₊XₙTₓ wherein M is a transition metal from the 3d to 5d blocks of groups 3-6 of the Periodic Table of Elements, X is carbon or nitrogen, Tₓ is a functional surface termination, and n is an integer from 1 to 4, the integer identifying a number of atomic layers of M interleaved by X; and a post-transition metal selected from aluminum, copper, zinc, gallium, germanium, arsenic, selenium, silver, cadmium, indium, tin, antimony, tellurium, gold, mercury, thallium, lead, bismuth, polonium, astatine, copernicium, nihonium, flerovium, moscovium, livermorium, tennessine, and a combination of two or more thereof; wherein the post-transition metal is at least partially encapsulated by from 1 to 4 layers of the MXene.

In embodiments, M is Ti.

In embodiments, X is carbon.

In embodiments, Tₓ is selected from ═O, —F, —Cl, —OH, —Br, —I, —Se, —Te, —S, and a combination of two or more thereof.

In embodiments, n is 2.

In embodiments, M is Ti, X is carbon, and n is 2.

In embodiments, the post-transition metal is aluminum.

In embodiments, the post-transition metal is completely encapsulated by from 1 to 4 layers of the MXene.

In embodiments, the post-transition metal is completely encapsulated by from 1 to 4 layers of the MXene. In some of these embodiments, the post-transition metal is aluminum.

In embodiments, a method of making the composite includes dispersing the post-transition metal in an organic carrier, thereby forming a first dispersion; dispersing the MXene in an aqueous carrier, thereby forming a second dispersion; mixing the first dispersion and the second dispersion, thereby forming a liquid phase and a solid precipitate comprising the composite; and collecting the solid precipitate, thereby forming the composite.

In embodiments, the method further comprises milling the post-transition metal in the organic carrier prior to mixing the first dispersion and the second dispersion.

In embodiments, the organic carrier comprises at least one alcohol.

In embodiments, the at least one alcohol comprises ethanol.

In embodiments, the aqueous carrier is distilled water.

In embodiments, the mixing comprises adding the first dispersion to the second dispersion; stirring the mixed first dispersion and second dispersion for from 5 minutes to 15 minutes; and allowing the solid precipitate to settle for from 30 seconds to 2 minutes.

In embodiments, the collecting comprises at least partially separating the liquid phase from the solid precipitate. In some of these embodiments, the at least partially separating comprises at least one of decanting, drying, filtering, evaporating, freeze-drying, sedimentation, crystallization, evaporating, or a combination of two or more thereof In some of these embodiments, the at least partially separating comprises removing the liquid phase such that the solid precipitate comprises no more than 100 micrograms of the liquid phase per 1 gram of the solid precipitate.

In embodiments, the composite has a Vickers microhardness from 100 HV to 250 HV.

In some embodiments of the method, M is Ti, X is carbon, and n is 2. In some of these embodiments, the post-transition metal is aluminum.

In embodiments, a composite comprises a MXene having a general formula of Mₙ₊₁XₙTₓ wherein M is a transition metal from the 3d to 5d blocks of groups 3-6 of the Periodic Table of Elements, X is carbon or nitrogen, Tₓ is a functional surface termination, and n is an integer from 1 to 4, the integer identifying a number of atomic layers of M interleaved by X; and a bulk ceramic selected from the group consisting of a carbide of titanium, a carbide of zirconium, a carbide of hafnium, a carbide of silicon, a carbide of tantalum, a carbide of niobium, a carbide of tungsten, a diboride of titanium, a diboride of zirconium, a diboride of hafnium, a diboride of tantalum, a diboride of niobium, an oxide of aluminum, an oxide of manganese, an oxide of tin, and a combination of two or more thereof wherein the bulk ceramic is at least partially encapsulated by from 1 to 4 layers of the MXene.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a schematic of selective etching and delamination of Ti₃C₂Tₓ from Ti₃AlC₂, resulting in surface terminated Ti₃C₂T₃, flakes, which appear black in solution.

FIG. 2 shows the zeta potential of Ti₃C₂T_{y} MXene black solution in which surfaces of these flakes are negatively charged, with an average zeta potential of −35.7±9.5 mV.

FIG. 3 shows a schematic of ball-milling, illustrating the exposure of a non-oxidized Al surface by ball milling spherical Al powder in a pure ethanol solution. The addition of water can ionize the surface of the Al forming Al³⁺.

FIG. 4 shows the effects of ball milling time and ball-to-powder ratio by mass (BPR) on the flake morphology (a-d) and size distribution (e-h). 20:1 BPR and 1 h ball milling is shown to have little effect on the morphology (a) and size distribution (e) of Al powder. 20:1 BPR and 24 h ball milling is shown to have more of an effect of Al morphology (b), but little effect on most Al powder size distribution (f). 20:1 BPR and 72 h ball milling has a large effect on Al morphology (c) and size distribution (g). However, 40:1 BPR for 24 h ball milling time is shown to have the most effect on Al morphology (d) and size distribution (h), which indicates BPR has a higher effect on flake morphology and size distribution.

FIG. 5 shows the zeta potential of as-received Al powder from a 40-80 vol % water concentration of an ethanol-water solution.

FIG. 6 shows the zeta potential of ball-milled Al powder after 24 h with a BPR of 40:1 from a 40-80 vol % water concentration of an ethanol-water solution. The zeta potential of Al in an ethanol-water solution increases when the Al is ball milled in ethanol due to the exposed Al surface.

FIG. 7 shows that mixed samples in 100 vol % water solution exhibit oxidation, which is clearly visible using energy-dispersive spectroscopy (EDS) and SEM. (a) SEM image of the surface of unmixed Al, which illustrates the regularly smooth surface of Al. (b) SEM image of the oxidized surface of mixed 2 wt % Ti₃C₂Tₓ-Al mixed in 100% water. Table S1 and S2 illustrates an EDS scan of the center of the SEM image in panel a and b, where panel b's SEM image shows a high oxygen content as compared to the content in panel a's SEM image.

FIG. 8 shows solution mixing process and self-assembly of Al flakes and Ti₃C₂Tₓ MXene solution. (a) Ball milled Al flakes in an ethanol solution (b) single-to-few-flake dispersion of Ti₃C₂Tₓ MXene in de-ionized water, (c) Mixture of Al and Ti₃C₂Tₓin a 60 vol % water and 40 vol % ethanol solution. (d) complete separation of 2 wt. % Ti₃C₂Tₓ-Al self-assembly from the ethanol-water solution after X minutes.

FIG. 9 shows XRD² of Al and Al reinforced by 1, 2, 5, and 10 wt % single-to-few layer and 5 wt % multi-layer flakes of Ti₃C₂Tₓₓ in a solid billet compressed at room temperature. (a-f) 10° 2θ still focus with exposure times of 15 minutes for all the samples. The spectra captured is 0° 1θ (leftmost side) to ˜25° (rightmost side). (g-l) Full spectra (5° to 75° 2θ) captured using a XRD² detector. Leftmost inset is the 10° 2θ still focus and rightmost inset is a small portion of the 60° 2θ still focus for all the samples. The dotted grey line throughout all full spectra images represents primary Al (111), (200), and (220) peaks. The rightmost inset in (h-l of the Ti₃C₂Tₓ-Al bulk samples have a dotted black line, which represents the center of the (110) peaks of Ti₃C₂Tₓ in the sample while the leftmost inset in (k-l) have a dotted black line which represent the (002) and (006) peaks of Ti₃C₂Tₓ. (m-r) 60° 2θ still focus with exposure times of 15 minutes for all the samples. The spectra captured is ˜45° (leftmost side) to ˜75° (rightmost side).

FIG. 10 provides electrostatic self-assembly process at 60 vol % water in a water-ethanol solution, which clearly illustrates the status of full adsorption visually. (a) <2 wt % Ti₃C₂Tₓ in the Al solution results in a mostly grey solution, which is indicative of still-stable Al in the solution without full Ti₃C₂Tₓ adsorption. (b) Clear solution indicates 2 wt % Ti₃C₂Tₓ in Al, which results in destabilization of dispersed particles and the formation of a sediment at the bottom. (c) >2 wt % Ti₃C₂Tₓ in Al results in a black solution, which indicates there is still stable Ti₃C₂Tₓ in the solution which is un-adsorbed to Al.

FIG. 11 shows that the electrostatic adsorption process is tunable. (a) Initial setup of Al dispersed in a water-ethanol solution with 60 vol % water concentration. (b) The addition of 1 wt % Ti₃C₂Tₓ does not result in full destabilization of all dispersed Al in the solution. (c) The addition of 1 wt % Ti₃C₂Tₓ illustrates some electrostatic adsorption of single-to-few layer Ti₃C₂Tₓ on the surface of Al. (d) 5 wt % Ti₃C₂Tₓ-Al in a water-ethanol solution with 60 vol % concentration of water results in non-adsorbed Ti₃C₂Tₓ dispersed in the solution. (e) 5 wt % Ti₃C₂Tₓ-Al in a water-ethanol solution with 70 vol % concentration of water results in full particle destabilization, which indicates completely adsorbed Ti₃C₂Tₓ with no Ti₃C₂Tₓ remaining dispersed in the solution. (f) Illustrates the adsorption of non-uniformly stacked Ti₃C₂Tₓ onto Al.

FIG. 12 demonstrates that solution mixing times should ordinarily be kept short, as extensions in mixing time from 10 min to 30 min results in clear oxidation noticeable in a slight color change visually (a & c). SEM images of 10 minutes result in a smooth topography of Al (b) while 30 minute mixing results in the formation of “grainy” Al₂O textures (d). XRD also detects the formation of Al₂O₃, visualized in (e).

FIG. 13 shows the mixture speeds may have an effect during the electrostatic adsorption process. (a) 600 RPM—10 min mixed 2 wt % Ti₃C₂Tₓ-Al in a water-ethanol solution with a 60 vol % water concentration (c) results in “chunking” where Ti₃C₂Tₓ flakes bridge Al particles as visualized in SEM. (b) 1000 RPM — 10 min mixed 2 wt % Ti₃C₂Tₓ-Al in a water-ethanol solution with a 60 vol % water concentration (d) results in single-to-few layer dispersions of Ti₃C₂Tₓ onto Al, visualized in SEM.

FIG. 14 demonstrates the mixing process of large-scale batches (4 g) of 2 wt % Ti₃C₂Tₓ-Al in a water-ethanol solution with concentration of 60 vol % water. (a-e) Shows the gradual addition and mixing of Ti₃C₂Tₓ in Al to result in fully destabilized Ti₃C₂Tₓ-Al in (f) once at 2 wt % total Ti₃C₂Tₓ.

FIG. 15 provides 2D versus OD detection of the (110) peak of Ti₃C₂Tₓ in Al. The OD detector is completed using a 120-minute scan of Ti₃C₂Tₓ-Al bulk samples from 59° 2θ to 64° 2θ while the 2D detector is a XRD² scan with 15 minute still exposure time centered at 60° 2θ. (a) Illustrates that 2 wt % Ti₃C₂Tₓ in Al is undetectable amongst the noise while using the 0D detector while the 2D detector illustrates an intense peak at the (110) Ti₃C₂Tₓ peak location, as marked by the dotted green line. (b) Illustrates that 5 wt % Ti₃C₂Tₓ (110) peak is detectable in Al with the 0D detector as shown by the dotted purple line, but is more clearly detectable using the 2D detector as shown by the dotted green line.

FIG. 16 demonstrates that crystalline Al₂O₃ formation can clearly be seen in 2 wt % Ti₃C₂Tₓ-Al samples using 2D XRD. (a) Marks the peak locations of Al signals and Al₂O₃ signals. Al₂O₃ signals are pointed out in locations of bright “dots” on the XRD² spectra. XRD² patterns are known to have small dots, which indicates vector diffraction, when referring to crystalline signals. Al is expected to be polycrystalline in nature, therefore, the ability to match the current crystalline formations to known Al₂O₃ peak locations indicates that some small crystalline formations of Al₂O₃ remain on the present sample. SEM images at lower magnification (b) and high magnification (c) support the hypothesis of small crystalline Al₂O₃ formation on the surface of Al due to oxidation.

FIG. 17 shows long acquisition scans at 10 ° 2θ of (a) 1 wt %, (b) 2 wt %, and (c) 5 wt % Ti₃C₂Tₓ-Al bulk samples using delaminated Ti₃C₂Tₓ do not show (00 [symbol] ) peaks of Ti₃C₂Tₓ, which indicate there is no uniform stacking of single-to-few layer Ti₃C₂Tₓ flakes.

FIG. 18 shows SEM images of Ti₃C₂Tₓ-Al self-assembled powder exhibiting near complete coverage of the Al flakes by Ti₃C₂Tₓ (e), with two higher magnification SEM images (f-3), which illustrates the single-to-few layer Ti₃C₂Tₓ coverage of Al's surface. The Ti₃C₂Tₓ flake coverage suggests that the adhesion of negatively charged Ti₃C₂Tₓ can cancel positively charged Al with a similar charge magnitude.

FIG. 19 shows SEM images of delaminated 5 wt % and ML 5 wt % Ti₃C₂Tₓ-Al illustrate the differences in Ti₃C₂Tₓ morphology. In panels (a) and (b), delaminated 5 wt % Ti₃C₂Tₓ-Al illustrates non-uniform restacking of Ti₃C₂Tₓ flakes, as shown by green arrows. In panels (b) and (c), delaminated 10 wt % Ti₃C₂Tₓ-Al illustrates a higher degree of restacking of Ti₃C₂Tₓ flakes, as shown by red arrows. In panels (e) and (f), multi-layer non-delaminated Ti₃C₂Tₓ illustrate ordered stacking of Ti₃C₂Tₓ flakes, as shown by red arrows. This disordered versus ordered restacking is likely the source of the inability to detect the (00 [symbol] ) peaks of delaminated 5 wt % Ti₃C₂Tₓ-Al bulk samples while the (00 [symbol] ) peaks of multi-layer non-delaminated 5 wt % Ti₃C₂Tₓ-Al bulk samples can be easily detect.

FIG. 20 shows full spectra XRD² scans of exfoliated and clay Ti₃C₂Tₓ samples. (a) Exfoliated, non-delaminated Ti₃C₂Tₓ has a strong (110) peak with small “dots”, which likely correspond to “grains” of multi-layer Ti₃C₂Tₓ flakes. (b) Expanded interlayer “clay” Ti₃C₂Tₓ also shows these dots, which indicates that multi-layer Ti₃C₂Tₓ flakes are still present even after intercalation with Li⁺ ions. (c) Comparative plot of the (110) peak of Ti₃C₂Tₓ in exfoliated and clay samples, where the (110) peaks are highlighted by a green and purple dotted line for exfoliated and clay Ti₃C₂Tₓ, respectively.

FIG. 21 shows thermal and mechanical behavior of Ti₃C₂Tₓ-Al composites annealed at 550° C. for 1 h. (a) The (311) peak shift of Al of all samples versus holding time at 550° C., which occurs due to thermal expansion of the Al lattice during high temperature annealing. (b) The shift of the (311) peak of Al can be used to calculate the TEC of the composite while the strain the in Al matrix can be calculated by comparing the peak shifting of the (311) peak. (c) Vickers hardness of pure Al and all the Ti₃C₂Tₓ-Al composites in this study post-annealing. The error bars indicate the standard deviation and the numbers above the graph indicate relative densification of the matrix. The inset shows a microscope image of the indentation, (d) In-situ XRD² of the (002) peak of Ti₃C₂Tₓ from room temperature (taken at 40° C.) up to 550° C. at increments of 100° C./step indicates slow broadening and right-shifting of the (002) peak until it disappears at 550° C. (e-f) Hypothesized mechanisms for behavior of the (002) peak of Ti₃C₂Tₓ during annealing of the Ti₃C₂Tₓ -Al composite include compression of the multi-layer stack as well as potential shearing or Al infiltration between the inter-layers of Ti₃C₂Tₓ. (g) Analysis of the (002) peak of Ti₃C₂Tₓ indicates a decreased inter-layer distance between flakes of Ti₃C₂Tₓ and an increasing FWHM during annealing. (h-i) SEM used in backscatter electron detection mode of the cross section of a fracture surface of the 5 wt % ML Ti₃C₂Tₓ-Al billets with EDS analysis used in line-scan mode across the Ti₃C₂Tₓ multi-layers. Arrows toward the bright spots are multi-layers of Ti₃C₂Tₓ. Panel (h) is of non-annealed room-temperature compressed 5 wt % ML Ti₃C₂Tₓ-Al billet while panel (i) is of a 550° C.—1 h annealed 5 wt % ML Ti₃C₂Tₓ-Al billet. Inset images in the SEM images display the x-axis of the EDS line scan as shown in the right-half of each panel h-i.

FIG. 22 shows plotting and FWHM analysis of the (311) peak of Al at room temperature (taken at 40° C.) and once the plot is at 550° C. (a) Raw plots of the (311) peak of Al at room temperature (taken at 40° C.) and once the plot is at 550° C. (b) Analysis of the FWHM of the (311) peak of Al at room temperature (taken at 40° C.) and when it reached the temperature of 550° C. (taken as 0 Min), 30 min after the temperature was reached (taken as 30 Min), and 1 h after the temperature was reached (taken as 60 Min). The FWHM was calibrated using a corundum standard as performed in previous studies, where the equipment contribution to the FWHM was determined to be ˜0.4° 2θ.

FIG. 23 is a raw plotting of the trend in the (002) peak of 10 wt % single-to-few layer Ti₃C₂Tₓ in Al. In these raw plots, the (002) peak becomes unintelligible from the background noise at roughly 300° C. Similar to the 5 wt % ML Ti₃C₂Tₓ in Al sample, the peak right-shifts during annealing, which indicates a compressive stress on the multi-layer Ti₃C₂Tₓ stacks.

FIG. 24 shows pre- and post-annealing spectra for all annealed Ti₃C₂Tₓ-Al samples, which indicate that no XRD-level clear new phases form as a result of annealing.

FIG. 25 is a secondary electron SEM micrograph of the fractured cross-section of the annealed 5 wt % ML Ti₃C₂Tₓ-Al billet in which FIG. 4i analyzes. The arrow indicates the exposed multi-layer Ti₃C₂Tₓ particle in which the EDS line scan analyzes.

FIG. 26 shows characterization data for various materials that may be used in ceramics. (a) Zeta potentials (in mV) for various oxides (zinc oxide, aluminum oxide and zirconium oxide) at pH 5; (b) Zeta potentials for various carbide and boride ceramics (Zirconium diboride, silicon carbide, zirconium carbide); (c) Zeta potential across a wide range of pH (2-7) for a mixture of ceramics (zirconium diboride-silicon carbide in a ratio of 80 vol %-20 vol %); (d) ZrB₂-MXene green bodies mixed at various wt % ratios showing a significant change in the color of the material (grey to black) with increase in MXene content; (e-i) and (e-ii) before and after mixing images of the green bodies of ZrB₂-MXene (2.5 wt %) showing self assembly and complete solute-solvent separation indicative of self-assembly; (e-iii) Transmission electron microscopy (TEM) images of the self-assembled ZrB₂-MXene clearly showing the grain coverage (dark areas are ceramic grains) with MXene flakes (translucent regions).

FIG. 27 shows characterization data of ceramic embodiments. (a-f) Green bodies of ZrB₂-MXene (without coverage) and 0.5 to 15 wt % MXene addition showing increase in number of MXene layers covering the ceramic grains; (g) X-Ray diffraction patterns of the green bodies (h) focused XRD scans at the 5.5-7.5 degrees and showing a increase in intensity of the MXene's (002) planes due to increase in MXene concentrations, (i) Increase in intensity of the (110) plane of MXene with increase in MXene concentration; (j) Diffraction images of the (002) plane showing increase in the emergence of peaks in the diffractograms with increase in MXene wt %.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

Unless defined otherwise, all technical and scientific terms have the same meaning as is commonly understood by one of ordinary skill in the art to which this disclosure belongs. All patents, applications, published applications and other publications are incorporated by reference in their entireties. If a definition set forth in this section is contrary to, or otherwise inconsistent with, a definition set forth in a patent, application, or other publication that is incorporated by reference, the definition set forth in this section prevails over the definition incorporated by reference.

As used in the description and the appended claims, the singular forms “a,” “an,” and “the” are intended to include the plural forms as well, unless the context clearly indicates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. The terms “including,” “containing,” and “comprising” are used in their open, non-limiting sense. Also as used herein, “and/or” refers to and encompasses any and all possible combinations of one or more of the associated listed items, as well as the lack of combinations when interpreted in the alternative (“or”).

The term “about,” as used herein when referring to a measurable value such as an amount of polypeptide, dose, time, temperature, enzymatic activity or other biological activity and the like, is meant to encompass variations of ±20%, ±10%, ±5%, ±1%, ±0.5%, or even ±0.1% of the specified amount. To provide a more concise description, some of the quantitative expressions are not qualified with the term “about.” It is understood that, whether the term “about” is used explicitly or not, every quantity is meant to refer to the actual given value, and it is also meant to refer to the approximation to such given value that would reasonably be inferred based on the ordinary skill in the art, including equivalents and approximations due to the experimental and/or measurement conditions for such given value.

The terms “including,” “containing,” and “comprising” are used in their open, non-limiting sense. The transitional phrase “consisting essentially of” means that the scope of a claim is to be interpreted to encompass the specified materials or steps recited in the claim, “and those that do not materially affect the basic and novel characteristic(s)” of the claimed subject matter. See, In re Herz, 537 F.2d 549, 551-52, 190 USPQ 461, 463 (CCPA 1976) (emphasis in the original); see also MPEP § 2111.03 (9^{th} edition, 10^{th} revision).

Embodiments disclosed herein include a composite containing both a MXene and a post-transition metal.

In embodiments, the MXene may have a general formula of Mₙ₊₁ XₙTₓ, where M is a transition metal from the 3d to 5d blocks of the International Union of Pure and Applied Chemistry (IUPAC) groups 3-6 of the Periodic Table of Elements, X is carbon or nitrogen, Tₓ is a functional surface termination, and n is an integer from 1 to 4, the integer identifying a number of atomic layers of M interleaved by X.

As noted above, M may be a transition metal from the 3d to 5d blocks of the International Union of Pure and Applied Chemistry (IUPAC) groups 3-6 of the Periodic Table of Elements. In embodiments, M is selected from Sc, Ti, V, Cr, Y, Zr, Nb, Mo, Tc, La, Hf, Ta, W, Re, or a combination of two or more of these. In embodiments, M comprises Ti. In embodiments, M is Ti.

In embodiments, X is carbon or nitrogen. In embodiments, X is carbon. In embodiments, X is nitrogen.

In embodiments, n is an integer from 1 to 4. That is, n may be 1, 2, 3, or 4, and the integer identifies the number of atomic layers of M interleaved by X.

In embodiments, Tₓ is a functional surface termination. In embodiments, Tₓ may be selected from ═O, —F, —Cl, —OH, —Br, —I, —Se, —Te, —S, and a combination of two or more thereof.

In embodiments, the composite includes a post-transition metal. In embodiments, the post-transition metal may be selected from aluminum, copper, zinc, gallium, germanium, arsenic, selenium, silver, cadmium, indium, tin, antimony, tellurium, gold, mercury, thallium, lead, bismuth, polonium, astatine, copernicium, nihonium, flerovium, moscovium, livermorium, tennessine, zirconium, tantalum, tungsten, niobium, hafnium, and a combination of two or more thereof. In embodiments, the post-transition metal may be aluminum.

In embodiments, the composite also includes ceramics. In embodiments, the ceramic may be selected from carbides of titanium, zirconium, hafnium, silicon, tantalum, niobium, tungsten, and/or diborides of titanium, zirconium, hafnium, tantalum, niobium and/or oxides of aluminum, manganese, tin or a combination of two or more thereof.

In embodiments, the MXene at least partially encapsulates the post-transition metal. That is, the MXene may cover a portion of the surface of the post-transition metal, such as at least 10% of the total surface area of the post-transition metal. For instance, the MXene may cover at least 10%, at least 20%, at least 30%, at least 40%, at least 50%, at least 60%, at least 70%, at least 80%, at least 90%, or even 100% of the total surface area of the post-transition metal. In embodiments, the MXene may cover from 10% to 100%, for 15% to 100%, from 20% to 100%, from 25% to 100%, from 30% to 100%, from 35% to 100%, from 40% to 100%, from 45% to 100%, from 50% to 100%, from 55% to 100%, from 60% to 100%, from 65% to 100%, from 70% to 100%, from 75% to 100%, from 80% to 100%, from 85% to 100%, from 90% to 100%, from 95% to 100%, from 10% to 95%, from 10% to 90%, from 10% to 85%, from 10% to 80%, from 10% to 75%, from 10% to 70%, from 10% to 65%, from 10% to 60%, from 10% to 55%, from 10% to 50%, from 10% to 45%, from 10% to 40%, from 10% to 35%, from 10% to 30%, from 10% to 25%, from 10% to 20%, or even from 10% to 15% of the total surface area of the post-transition metal.

In embodiments, the post-transition metal or ceramic may be at least partially encapsulated by from 1 to 4 layers of the MXene. For example, the post-transition metal or ceramic may be at least partially encapsulated by 1, 2, 3, or 4 layers of the MXene. In addition, individual regions of the post-transition metal or ceramic may be at least partially encapsulated by the same number of layers of MXene or by a different number of layers of the MXene. For instance, one region of the surface area of post-transition metal or ceramic may bear a single layer of the MXene and a second region of the surface area of post-transition metal or ceramic may bear two or more layers of the MXene, such as 2, 3, or 4 layers.

In embodiments, the composite may include from 85 weight percent (“wt %”) to 99 wt % of the post-transition metal or ceramic and from 1 wt % to 15 wt % of the MXene, based on the total weight of the composite. For example, the composite may include 1 wt %, 2 wt %, 5 wt %, or 10 wt % of the MXene and 99 wt %, 98 wt %, 95 wt %, or 90 wt %, respectively, of the post-transition metal. In embodiments, the composite may include from 85 wt % to 99 wt %, from 85 wt % to 98 wt %, from 85 wt % to 97 wt %, from 85 wt % to 96 wt %, from 85 wt % to 95 wt %, from 85 wt % to 94 wt %, from 85 wt % to 93 wt %, from 85 wt % to 92 wt %, from 85 wt % to 91 wt %, from 85 wt % to 90 wt %, from 85 wt % to 89 wt %, from 85 wt % to 88 wt %, from 85 wt % to 87 wt %, from 85 wt % to 86 wt %, from 86 wt % to 99 wt %, from 87 wt % to 99 wt %, from 88 wt % to 99 wt %, from 89 wt % to 99 wt %, from 90 wt % to 99 wt %, from 91 wt % to 99 wt %, from 92 wt % to 99 wt %, from 93 wt % to 99 wt %, from 94 wt % to 99 wt %, from 95 wt % to 99 wt %, from 96 wt % to 99 wt %, from 97 wt % to 99 wt %, or even from 98 wt % to 99 wt % of the post-transition metal. In embodiments, the composite may include from 1 wt % to 15 wt %, from 1 wt % to 14 wt %, from 1 wt % to 13 wt %, from 1 wt % to 12 wt %, from 1 wt % to 11 wt %, from 1 wt % to 10 wt %, from 1 wt % to 9 wt %, from 1 wt % to 8 wt %, from 1 wt % to 7 wt %, from 1 wt % to 6 wt %, from 1 wt % to 5 wt %, from 1 wt % to 4 wt %, from 1 wt % to 3 wt %, from 1 wt % to 2 wt %, from 2 wt % to 15 wt %, from 3 wt % to 15 wt %, from 4 wt % to 15 wt %, from 5 wt % to 15 wt %, from 6 wt % to 15 wt %, from 7 wt % to 15 wt %, from 8 wt % to 15 wt %, from 9 wt % to 15 wt %, from 10 wt % to 15 wt %, from 11 wt % to 15 wt %, from 12 wt % to 15 wt %, from 13 wt % to 15 wt %, or even from 14 wt % to 15 wt % of the MXene.

In embodiments, the resulting composite may have Vickers microhardness from 100 HV to 250 HV, from 100 HV to 225 HV, from 100 HV to 200 HV, from 100 HV to 175 HV, from 100 HV to 150 HV, from 100 HV to 125 HV, from 125 HV to 250 HV, from 150 HV to 250 HV, from 175 HV to 250 HV, from 200 HV to 250 HV, or even from 225 HV to 250 HV.

In embodiments, the resulting ceramic composite may have Vickers microhardness from 1800 HV to 1850 HV, 1850 to 1900 HV, 1900 to 1950 HV, 1950 to 2000 HV, 2000 to 2050 HV, 2000 to 2100 HV, 2100 to 2200 HV, 2200 HV to 2300 HV, 2300 to 2400 HV, 2400 to 2500 HV, 2500 to 2600 HV, 2600 to 2700 HV, 2700 to 2800 HV, 2800 to 2900 HV, or even from 2900 to 3000 HV.

In the embodiments, the fracture toughness of the resulting ceramic composite may be from 1 MPa m^{1/2} to 1.5 MPa m^{1/2}, 1.5 MPa m^{1/2} to 2 MPa m^{1/2}, 2.5 MPa m^{1/2} to 3 MPa m^{1/2}, 3.5 MPa M^{1/2} to 4.0 MPa m^{1/2}, 4.0 MPa m^{1/2} to 4.5 MPa m^{1/2}, 4.5MPa m^{1/2} to 5 MPa m^{1/2}, 5 MPa m^{1/2} to 5.5 MPa m^{1/2}, 5.5 MPa M^{1/2} to 6 MPa m^{1/2}, 6 MPa M^{1/2} to 6.5 MPa m^{1/2}, 6.5 MPa m^{1/2} to 7 MPa m^{1/2}, 7 MPa m^{1/2} to 7.5 MPa m^{1/2} or even 7 MPa M^{1/2} to 7.5 MPa m^{1/2}.

In embodiments, a method of making the composite described above may include dispersing the post-transition metal or ceramic in an organic carrier, thereby forming a first dispersion; dispersing the MXene in an aqueous carrier, thereby forming a second dispersion; mixing the first dispersion and the second dispersion, thereby forming a liquid phase and a solid precipitate comprising the composite; and collecting the solid precipitate, thereby forming the composite.

In some embodiments, the post-transition metal or ceramic in the organic carrier prior to mixing the first dispersion and the second dispersion. This step may help expose non-oxidized surfaces of the post-transition metal. For instance, in embodiments, the surface of Al may be oxidized to include a layer of Al₂O₃ on that surface. In embodiments, the milling is ball milling. In embodiments, the organic carrier may comprise a lower alcohol, such as methanol, ethanol, iso-propanol, n-propanol, and the like. In embodiments, the organic carrier is ethanol. Additionally, for self-assembly in the ceramic embodiments, ceramic particles may be mixed in acid solutions of pH 1 to pH 6, followed by mixing the acid solutions with MXene black solutions.

As noted above, a second dispersion may be formed by dispersing the MXene in an aqueous carrier. In embodiments, the aqueous carrier may include water with dissolved ions, such as water from a municipal source or a subterranean well. In other embodiments, the water may comprise purified water, distilled water, distilled and deionized water, or a combination of two or more thereof

Mixing the first dispersion and the second dispersion, thereby forming a liquid phase and a solid precipitate comprising the composite, may include adding the first dispersion to the second dispersion; stirring the mixed first dispersion and second dispersion for from 5 minutes to 15 minutes; and allowing the solid precipitate to settle for from 30 seconds to 2 minutes. For example, the stirring may be from 5 minutes (“min”) to 15 min, from 5 min to 14 min, from 5 min to 13 min, from 5 min to 12 min, from 5 min to 11 min, from 5 min to 10 min, from 5 min to 9 min, from 5 min to 8 min, from 5 min to 7 min, from 5 min to 6 min, from 6 min to 15 min, from 7 min to 15 min, from 8 min to 15 min, from 9 min to 15 min, from 10 min to 15 min, from 11 min to 15 min from 12 min to 15 min, from 13 min to 15 min, or even from 14 min to 15 min. In embodiments, the solid precipitate may be allowed to settle for from 30 seconds (“s”) to 2 min, from 1 min to 2 min, from 1.5 min to 2 min, from 30 s to 1.5 min, or even from 30 s to 1 min.

After the precipitate forms, the liquid phase and solid phase may be separated. In embodiments, the liquid phase is at least partially separated from the solid phase. In embodiments, the liquid phase is fully separated from the solid phase. Of course, as one of ordinary skill would be well aware, “fully separated” includes not only that no liquid phase remains on the solid phase but also that a trace amount of the liquid phase may remain on the solid phase. For instance, “fully separated” would include collecting the solid phase with up to 100 parts per million (100 micrograms of liquid phase per 1 gram of solid phase) of the liquid phase remaining on the solid phase. In embodiments, the at least partially separating may include at least one of decanting, drying, filtering, evaporating, freeze-drying, sedimentation, crystallization, evaporating, or a combination of two or more thereof. In embodiments, the at least partially separating includes decanting, filtering, and drying, such as decanting a majority of the liquid phase from the solid phase, filtering the solid phase through a filter paper, and then drying the resulting solid in an oven. In embodiments, this oven may be a vacuum oven.

In addition to the aspects and embodiments described and provided elsewhere in the present disclosure, the following non-limiting list of embodiments are also contemplated.

1. A composite comprising:

a MXene having a general formula of

Mₙ₊₁XₙTₓ
wherein
   M is a transition metal from the 3d to 5d blocks of groups 3-6 of the Periodic Table of Elements,
   X is carbon or nitrogen,
   Tₓ is a functional surface termination, and
   n is an integer from 1 to 4, the integer identifying a number of atomic layers of M interleaved by X; and

a post-transition metal selected from aluminum, copper, zinc, gallium, germanium, arsenic, selenium, silver, cadmium, indium, tin, antimony, tellurium, gold, mercury, thallium, lead, bismuth, polonium, astatine, copernicium, nihonium, flerovium, moscovium, livermorium, tennessine, and a combination of two or more thereof;

wherein the post-transition metal is at least partially encapsulated by from 1 to 4 layers of the MXene.

2. The composite of clause 1, wherein M is Ti.

3. The composite of clause 1 or clause 2, wherein X is carbon.

4. The composite of any one of clauses 1 to 3, wherein Tₓ is selected from ═O, —F, —Cl, —OH, —Br, —I, —Se, —Te, —S, and a combination of two or more thereof.

5. The composite of any one of clauses 1 to 4, wherein n is 2.

6. The composite of any one of clauses 1 to 5, wherein M is Ti, X is carbon, and n is 2.

7. The composite of any one of clauses 1 to 6, wherein the post-transition metal is aluminum.

8. The composite of any one of clauses 1 to 7, wherein the post-transition metal is completely encapsulated by from 1 to 4 layers of the MXene.

9. The composite of clause 6, wherein the post-transition metal is completely encapsulated by from 1 to 4 layers of the MXene.

10. The composite of clause 9, wherein the post-transition metal is aluminum.

11. A method of making the composite of clause 1, the method comprising:

dispersing the post-transition metal in an organic carrier, thereby forming a first dispersion;

dispersing the MXene in an aqueous carrier, thereby forming a second dispersion;

mixing the first dispersion and the second dispersion, thereby forming a liquid phase and a solid precipitate comprising the composite; and

collecting the solid precipitate, thereby forming the composite.

12. The method of clause 11, further comprising milling the post-transition metal in the organic carrier prior to mixing the first dispersion and the second dispersion.

13. The method of clause 11 or clause 12, wherein the organic carrier comprises at least one alcohol.

14. The method of clause 13, wherein the at least one alcohol comprises ethanol.

15. The method of any one of clauses 11 to 14, wherein the aqueous carrier is distilled water.

16. The method of any one of clauses 11 to 15, wherein the mixing comprises:

adding the first dispersion to the second dispersion;

stirring the mixed first dispersion and second dispersion for from 5 minutes to 15 minutes; and allowing the solid precipitate to settle for from 30 seconds to 2 minutes.

17. The method of any one of clauses 11 to 16, wherein the collecting comprises:

at least partially separating the liquid phase from the solid precipitate.

18. The method of clause 17, wherein the at least partially separating comprises at least one of decanting, drying, filtering, evaporating, freeze-drying, sedimentation, crystallization, evaporating, or a combination of two or more thereof.

19. The method of clause 17, wherein the at least partially separating comprises removing the liquid phase such that the solid precipitate comprises no more than 100 micrograms of the liquid phase per 1 gram of the solid precipitate.

20. The method of any one of clauses 11 to 19, wherein the composite has a Vickers microhardness from 100 HV to 250 HV.

21. The method of any one of clauses 11 to 20, wherein M is Ti, X is carbon, and n is 2.

22. The method of clause 21, wherein the post-transition metal is aluminum.

23. A composite comprising:

a MXene having a general formula of

Mₙ₊₁XₙTₓ

wherein
M is a transition metal from the 3d to 5d blocks of groups 3-6 of the Periodic Table of Elements,
X is carbon or nitrogen,
Tₓ is a functional surface termination, and
n is an integer from 1 to 4, the integer identifying a number of atomic layers of M interleaved by X; and

a bulk ceramic selected from the group consisting of a carbide of titanium, a carbide of zirconium, a carbide of hafnium, a carbide of silicon, a carbide of tantalum, a carbide of niobium, a carbide of tungsten, a diboride of titanium, a diboride of zirconium, a diboride of hafnium, a diboride of tantalum, a diboride of niobium, an oxide of aluminum, an oxide of manganese, an oxide of tin, and a combination of two or more thereof;

wherein the bulk ceramic is at least partially encapsulated by from 1 to 4 layers of the MXene.

### EXAMPLES

Examples related to the present disclosure are described below. In most cases, alternative techniques can be used. The examples are intended to be illustrative and are not limiting or restrictive to the type, nature or composition of the embodiment of the material, or the scope of the invention as set forth in the claims.

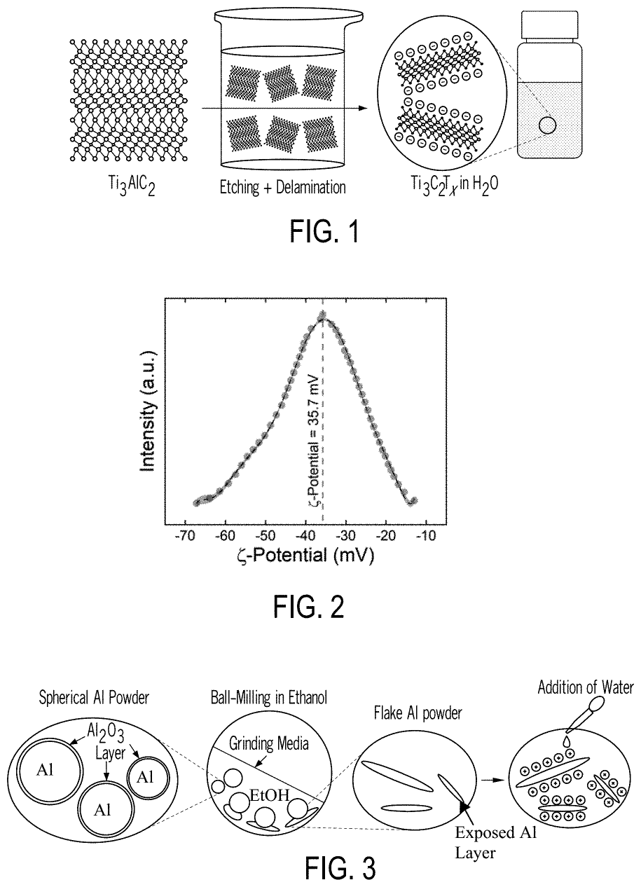

To begin a self-assembly process of Ti₃C₂Tₓ MXene to the Al matrix, Ti₃C₂Tₓ, synthesis is conducted similar to previously established synthesis methods and is described fully below. After the synthesis process, Ti₃C₂Tₓ is fully dispersed in water. The etching method of Ti₃C₂Tₓ from its Ti₃AlC₂ MAX phase precursor and MXene's final dispersion in water is shown in FIG. 1. Due to MXenes' surface groups, MXenes have a negative surface charge in water or polar organic solvents, such as ethanol. To characterize this surface charge of Ti₃C₂Tₓ in water, the zeta potential of the Ti₃C₂Tₓ dispersion is measured. As shown in FIG. 2, the zeta potential was −35.7±9.5 mV in de-ionized water, which agrees with previous studies.

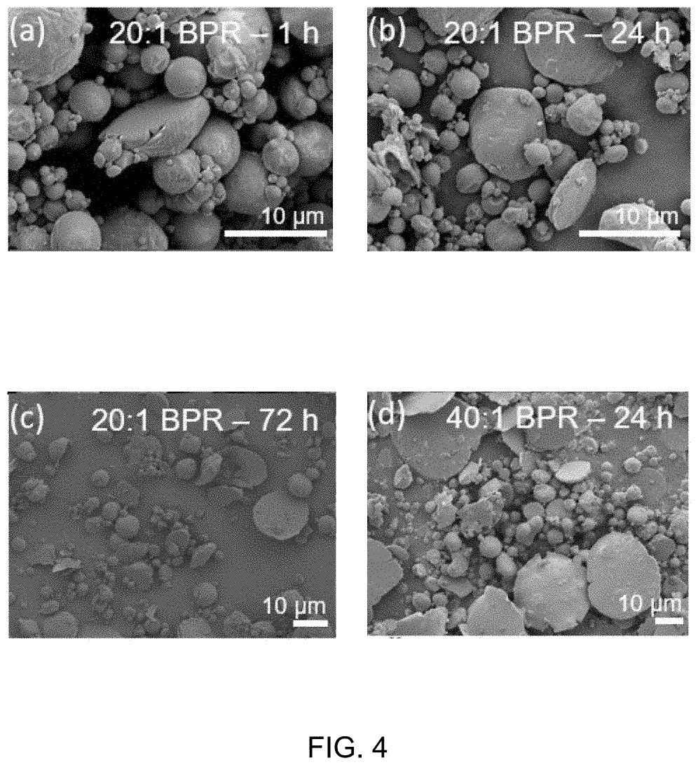

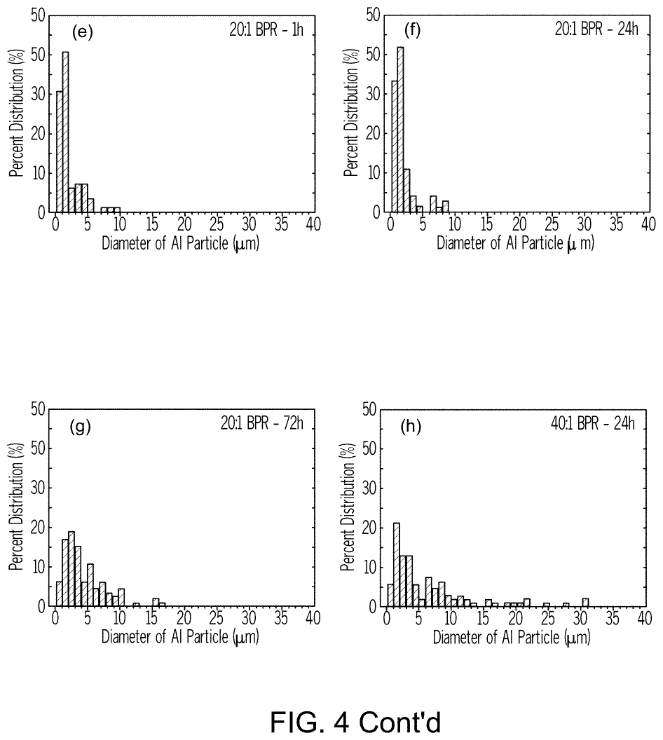

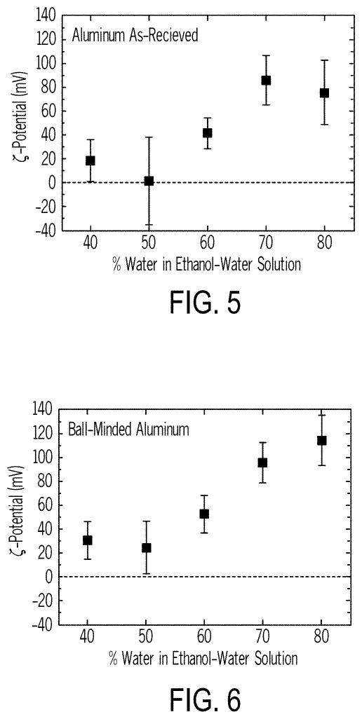

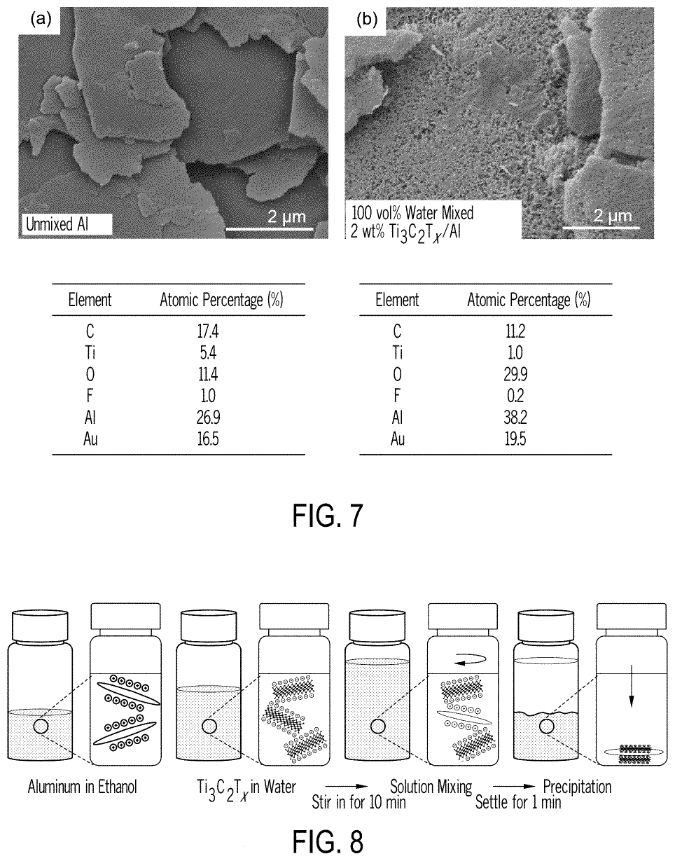

After synthesis of Ti₃C₂Tₓ, Al powders were prepared for electrostatic self-assembly, as described fully below. Since the surface of Ti₃C₂Tₓ is negatively charged, the electrostatic self-assembly process described herein requires the surface of Al to have a positive charge. To do so, it is necessary to alter the surface of Al to an Al³⁺ oxidation state. Al is ionized in the presence of water, however, the rate is slowed by the 3-4 nm thick native Al₂O₃ layer on the surface. The rate of ionization of Al can be increased by exposing non-oxidized Al surfaces before the introduction of water. A rolling jar ball milling, as shown in FIG. 3, was used to expose fresh surfaces of Al in an ethanol solution. Ethanol is used to prevent the formation of Al₂O₃ on the fresh surfaces. A 24 h ball milling at a ball to powder ration (“BPR”) of 40:1 was found to optimally deform Al spheres to Al flakes with fresh surface, as shown in FIG. 4. This process converted spherical Al powder with a diameter of 2.04 μm into Al flakes with an average of 5.88 μm diameter. This process exposed fresh Al surfaces measured by an increase in surface area of Al at an average of 300%. Next, the effect of different concentrations of water solution on the zeta potential of the dispersed Al in the ethanol-water solution was explored, as shown in FIG. 5 and FIG. 6. The positive surface charge of Al increased in both types of Al (as received and ball milled) as the water concentration increased from 40 vol % to 80 vol %. However, the ball-milled Al flakes illustrated an average ˜25% increase in zeta potential as compared to the as-received Al powder. Although the surface charge of Al continually increased with an increased concentration of water, a 100 vol % concentration solution of water results in formation of Al₂O₃ particles on the surface of Al as indicated by scanning electron microscopy (“SEM”) and energy dispersive spectroscopy (“EDS”), summarized in FIG. 7. Therefore, a mixture of water and ethanol was used to promote electrostatic adsorption of Ti₃C₂Tₓ to ball milled Al and mitigate the oxidative effects of water during mixture.

After the effects of deionized (“DI”) water addition on the surface charge and oxidation of the ball milled Al were examined, the electrostatic self-assembly of ball-milled Al with Ti₃C₂Tₓ was performed. A 60 vol % concentration of water was used due to the i) relatively high positive zeta potential of the ball-milled Al (52.0±16.2 mV), which may result in single-to-few layer assembly of Ti₃C₂Tₓ (˜35.7±9.5 mV) by neutralization of surface charges; and ii) slow oxidation of Al as compared to mixture in pure water. To make the self-assembled Ti₃C₂Tₓ-Al powder, the milled Al flakes in pure ethanol were added to a glass container, as shown in panel a of FIG. 8, and then water was added to achieve a concentration of 60 vol % water. To fully cover the surface of the Al flake size, a necessary weight fraction of Ti₃C₂Tₓ in Al was calculated to be 1.96 wt % using 1 nm as the thickness for Ti₃C₂Tₓ, ˜100 nm average thickness and 5.88 μm diameter of Al flakes, and 4.2 g·cm⁻³ and 2.7 g·cm⁻³ for the densities of Ti₃C₂Tₓ and Al, respectively. This weight fraction was tested experimentally through the addition of Ti₃C₂Tₓ (panel b of FIG. 8) drop-wise into Al solution while mixing (panel c of FIG. 8). In this experiment, ˜2 wt % of Ti₃C₂Tₓ flakes resulted in a near-clear solution (panel d of FIG. 8). Without intending to be bound by any particular theory, it is believed that the sedimentation of Ti₃C₂Tₓ-Al suggests cancellation of the surface charges between Ti₃C₂Tₓ and Al, resulting in an unstable Ti₃C₂Tₓ -Al particle, which causes separation from the solution.

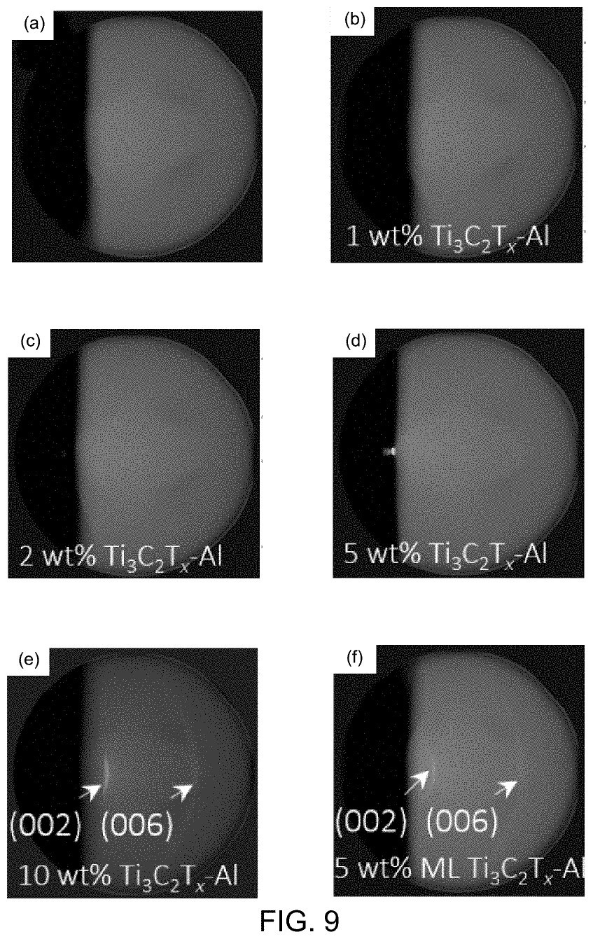

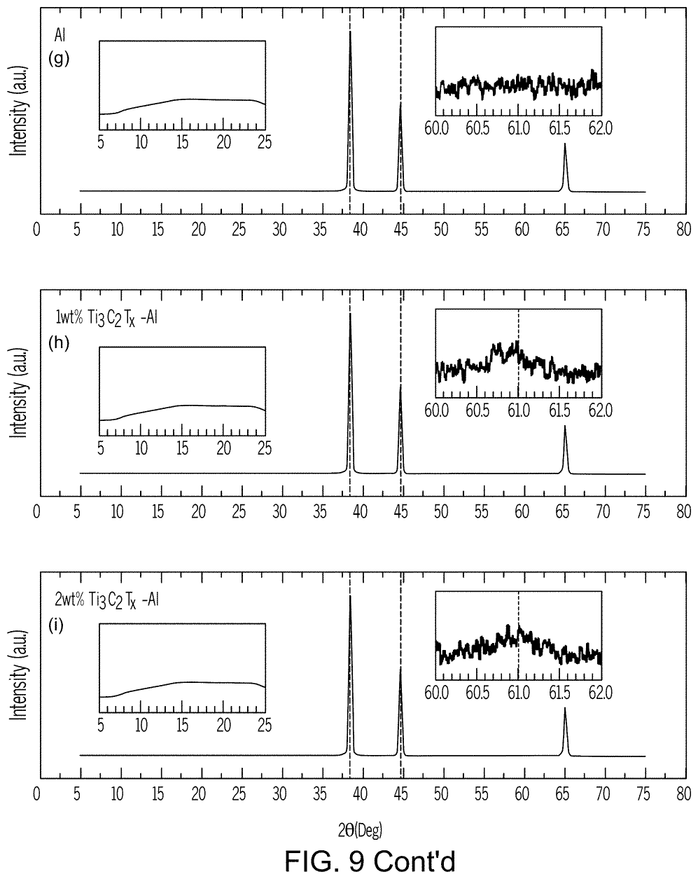

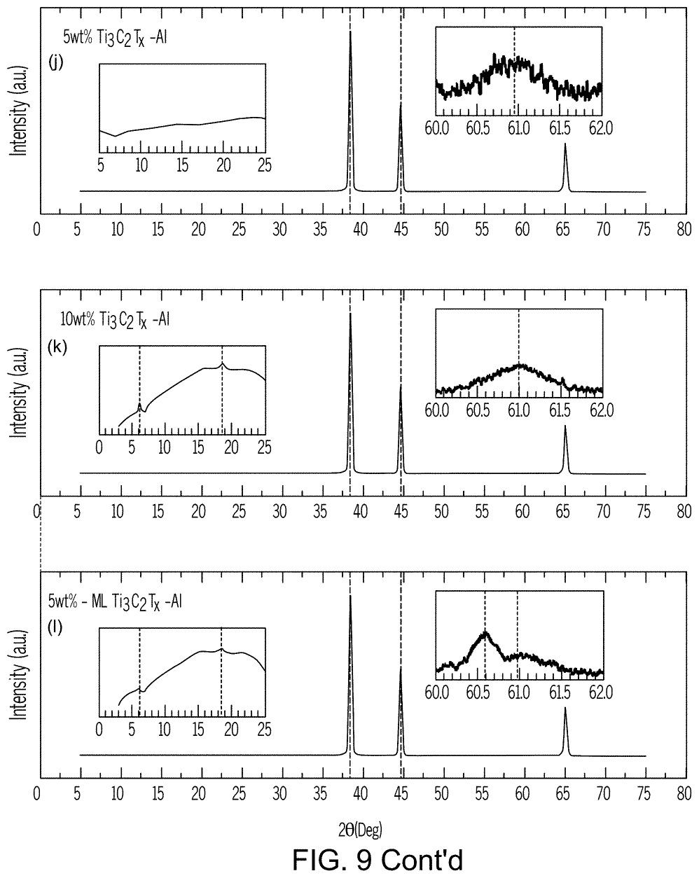

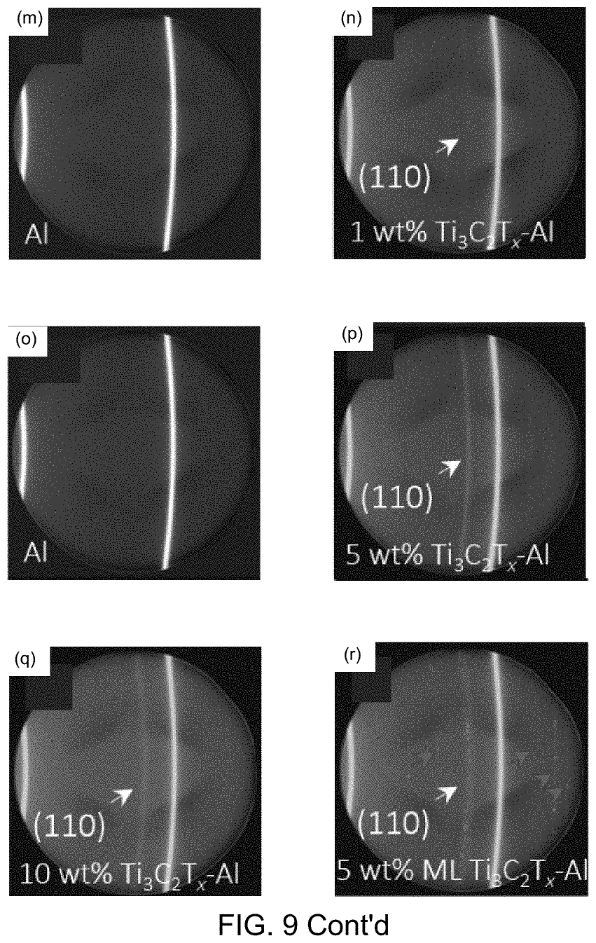

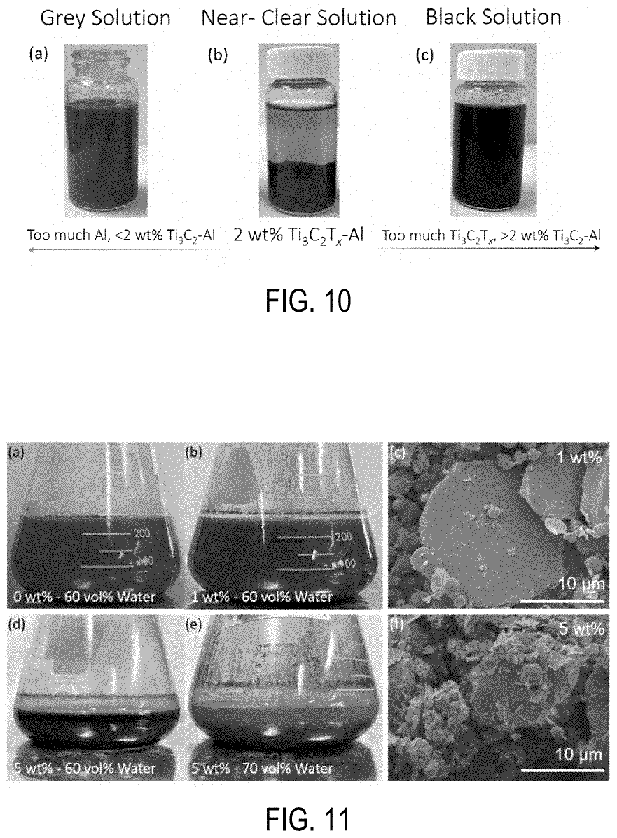

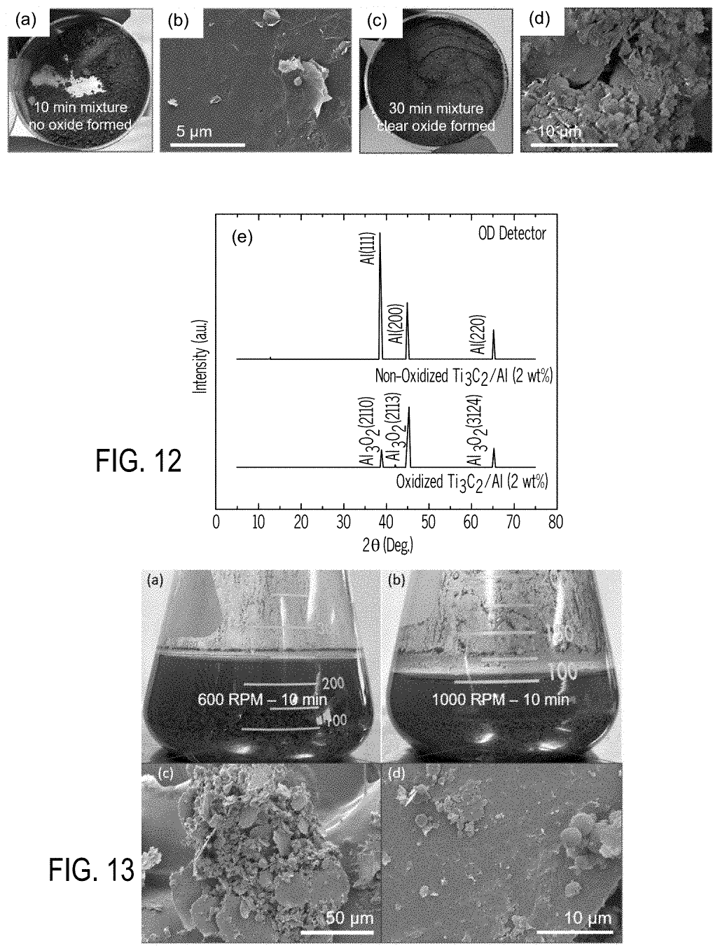

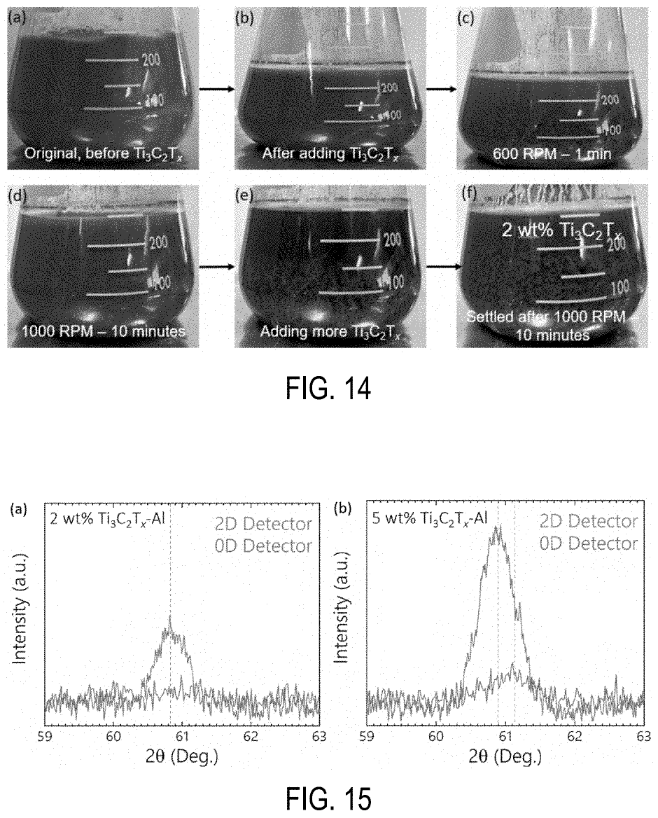

The destabilization of negatively charged Ti₃C₂Tₓ and positively ball-milled Al (with almost similar values) at 2 wt % in solution suggests near-complete coverage of the Al with single to few-flake Ti₃C₂Tₓ, as evidenced by FIG. 9. The non-destabilized weight fractions of Ti₃C₂Tₓ with Al was also evaluated at fractions lower or higher than 2 wt % Ti₃C₂Tₓ (FIG. 10). When using less than 2 wt % Ti₃C₂Tₓ flakes, a grey solution resulted after mixing, which is evident of still-dispersed Al, and only results in partial coverage (FIG. 11). Furthermore, greater than 2 wt % Ti₃C₂Tₓ flakes resulted in a dark green/black solution, which is evident of still-dispersed Ti₃C₂Tₓ flakes after mixing. One method to increase the MXene content with successful self-assembly is to increase the water concentration in the solution from 60 vol % to 70 vol %. This increases the surface charge of the Al from 52±16.2 mV to 95±16.6 mV (see FIG. 6), which permits higher content assembly of Ti₃C₂Tₓ (5 wt %) to Al before destabilization (FIG. 11), but makes mitigation of oxidation more difficult (FIG. 7). Mixing times (FIG. 12) and stir rate (FIG. 13) affected the Ti₃C₂Tₓ dispersion. In addition, the electrostatic adsorption process proved to be scalable for applications requiring a larger amount of a Ti₃C₂Tₓ-Al powder mixture (FIG. 14). Without intending to be bound by any particular theory, it is believed that the scalability and tunability of the electrostatic adsorption process suggests this process is feasible for additive manufacturing toward the formation of bulk Ti₃C₂Tₓ-Al metal nanocomposites.

Afterwards, methods of identification of Ti₃C₂Tₓ in a bulk Al sample were explored. A solid sample was formed as described fully below. The room-temperature compaction approach reached around 84±2% densification amongst Al and 1, 2, and 5 wt % Ti₃C₂Tₓ-Al powders. Afterwards, XRD was conducted to identify Ti₃C₂Tₓ in the bulk sample. First, traditional zero-dimensional point (OD) powder XRD was performed, which did not detect Ti₃C₂Tₓ at or lower than 2 wt %, even at long scan times, as shown in FIG. 15. Without intending to be bound by any particular theory, it is believed that this was due to the low diffraction signal of Ti₃C₂Tₓ at low weight fractions (<2 wt %). Previous studies have identified that traditional OD XRD captures a limited amount of the available diffraction signal. The use of 2D XRD (“XRD²”) improves the ability to capture a larger portion of this data, thereby possibly increasing chances of capturing the low diffraction signal of Ti₃C₂Tₓ in bulk Al. Therefore, XRD² was used to detect a small amount of Ti₃C₂Tₓ (≤2 wt %) in bulk Al.

XRD² was used to detect standard Ti₃C₂Tₓ peaks. The (002) peak, if present, would appear between 5-10° 2θ based on the flakes interlayer distance and the (110) peaks of Ti₃C₂Tₓ at 2θ˜61°. In addition, XRD² scans can identify any Al₂O₃ possibly formed during the process. FIG. 9 illustrates the raw XRD² scans and full spectra scans for Al and Al reinforced by 1, 2, 5, and 10 wt % single-to-few layer and 5 wt % multi-layer flakes of Ti₃C₂Tₓ in a solid billet compressed at room temperature. Panels a through f of FIG. 9 show a focused 10° 2θ still XRD² scan for all the samples and panels g through 1 of FIG. 9 illustrate the full spectra scans. The dashed lines running through all full spectra scans represent standard (111), (200), and (220) peaks of Al from left to right, respectively. The spectrum of the 10° 2θ and 60° 2θ focused scans for each of the samples are shown as the leftmost and rightmost insets, respectively, in panels g through 1 of FIG. 9. Finally, panels m through r of FIG. 9 illustrate a focused 60° 2θ still XRD² scan for Al and Al reinforced by 1, 2, 5, and 10 wt % single-to-few layer and 5 wt % multi-layer flakes of Ti₃C₂Tₓ, respectively.

To confirm the presence of Ti₃C₂Tₓ in these metal matrix composite billets, the XRD² data were analyzed to identify the in-plane (110) and out-of-plane (00 [symbol] ) diffractions of Ti₃C₂Tₓ. The analysis of the data around 61°, where the Ti₃C₂Tₓ (110) peak is expected, indicated while there is not peak in pure Al samples, a peak at 61° is detected in 1, 2, 5, and 10 wt % Ti₃C₂Tₓ composites, corresponding to Ti₃C₂Tₓ (110), as shown in the right insets in panels g through 1 of FIG. 9. The raw XRD² scans illustrate these peaks faintly around the center of the circular scan, which is pointed by an arrow in panels m through r of FIG. 9. The presence of this peak in the Ti₃C₂Tₓ- containing samples, which is not seen in the pure Al samples, confirms the presence of Ti₃C₂Tₓ in the Ti₃C₂Tₓ-Al bulk samples. The increase in intensity of (110) ˜61° 2θ peak with increasing the concentration of Ti₃C₂Tₓ, from 1 wt % to 10 wt % Ti₃C₂Tₓ in Al, confirms this peak is due to the increased concentration of Ti₃C₂Tₓ. To confirm the described method does not lead to oxide formation (Al₂O₃) and to examine the detection of Al₂O₃ nano particle formation, the Ti₃C₂Tₓ-Al was mixed in water-ethanol solution for longer time (30 minutes) to increase the chance of Al oxidation. The XRD² results (FIG. 16) showed peaks of small crystalline Al₂O₃ using XRD². Because none of the Al₂O₃ peaks are detected in the composite samples (FIG. 9) it is fair to conclude that the mixing method does not lead to Al₂O₃ formation.

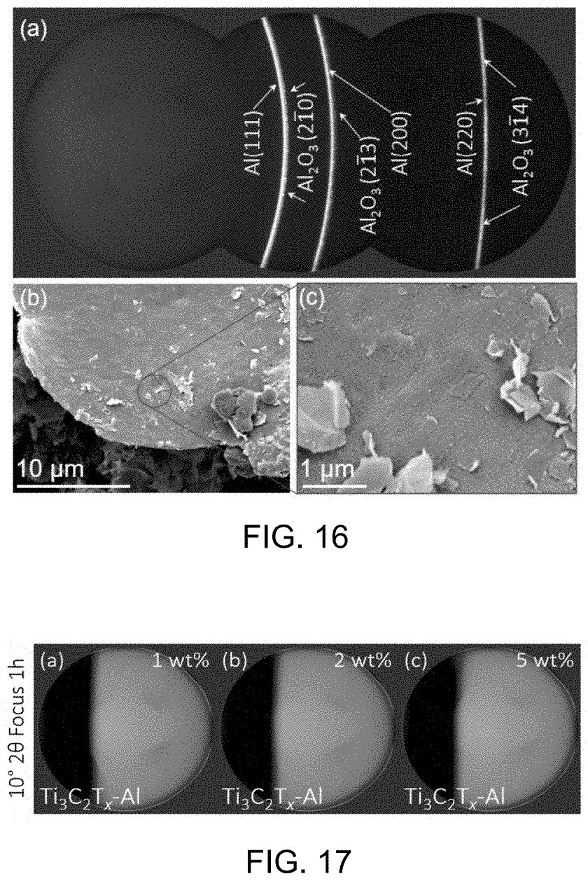

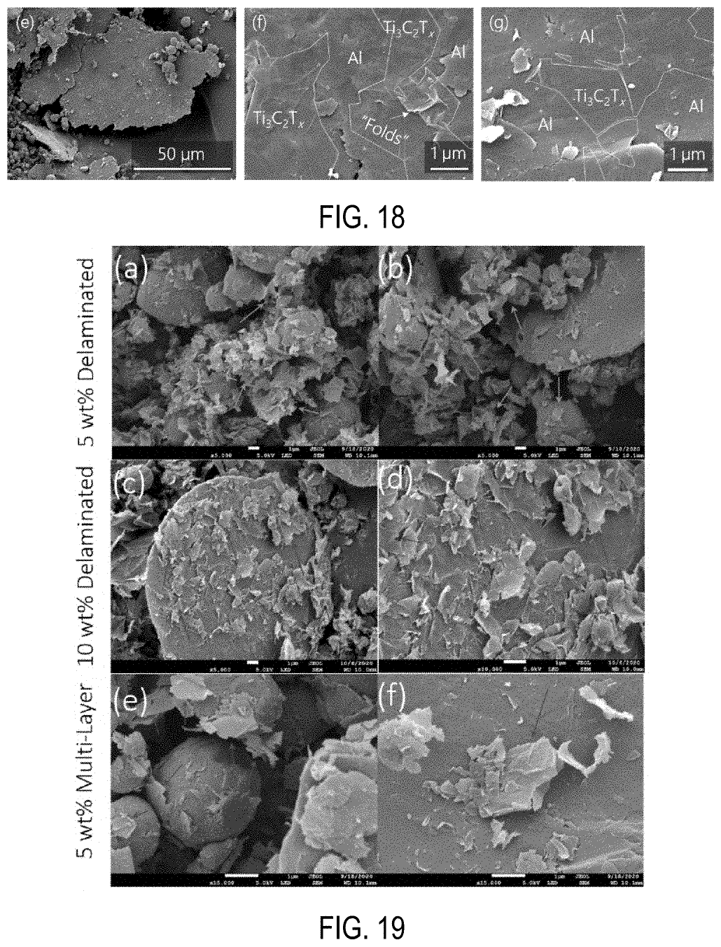

The (00 [symbol] ) peaks of Ti₃C₂Tₓ in the bulk Ti₃C₂Tₓ-Al were not detectable in the 10° 2θ focus (0° to 25°) scans at 15 min acquisition times up to a 5 wt % inclusion of single-to-few layer Ti₃C₂Tₓ (panels a to d of FIG. 9). To ensure that this was a feature of the sample and not scan time, the scan times for 1-5 wt % inclusions of Ti₃C₂Tₓ in Al at 10° 2θ were further increased to 1 hour. However, the (00 [symbol] ) peaks in the single-to-few layer 1, 2, and 5 wt % Ti₃C₂Tₓ-Al bulk samples (FIG. 17) were still unable to be detected. Without intending to be bound by any particular theory, a possible explanation for phenomena could potentially be that the (00 [symbol] ) peaks of Ti₃C₂Tₓ are of the basal plane, which is based on out-of-plane lattice parameters. Although in most Ti₃C₂Tₓ films, the MXene has been fully delaminated, these (00 [symbol] ) peaks are commonly seen in diffraction patterns because of regularly stacked flakes in free-standing films across a wide variety of MXene compositions and their composites. As evidenced by the SEM images shown in FIG. 18, dispersions of Ti₃C₂Tₓ are mostly single flakes with no stacking order. Based on geometry calculations, 5 wt % single-to-few layer Ti₃C₂Tₓ creates almost 3-4 layer stacked Ti₃C₂Tₓ coverage of Al particle. It was shown recently that by stacking three layers of Ti₃C₂Tₓ films on a glass slide, the (002) peak can be detected. However, in dealing with few-layer stacking of MXene, the out-of-plane peaks are highly dependent on alignment of the basal planes. For example, about 20-nm thick Ti₃C₂Tₓ MXene film was previously used to detect the (00 [symbol] ) peak. In any event, MXene films were stacked and XRD were analyzed in the presence of no other material. Without intending to be bound by any particular theory, it is believed that the lack of (00 [symbol] ) peaks could be due to a limited number of Ti₃C₂Tₓ flakes stacked at the Al grain boundaries. Higher concentration of Ti₃C₂Tₓ (10 wt %) as well as partially delaminated 5 wt % multi-layer (5 wt % ML) clay Ti₃C₂Tₓ were examined to support this finding.

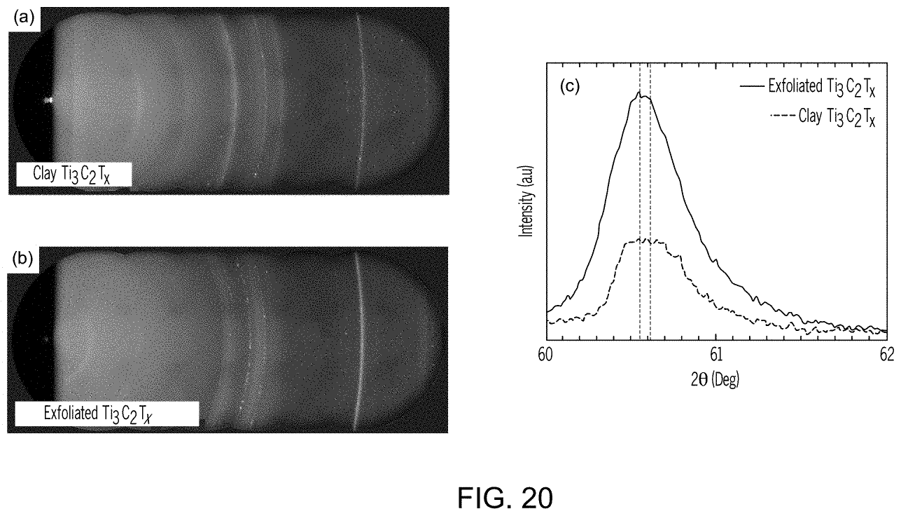

In the XRD² scans of 10 wt % Ti₃C₂Tₓ-Al and 5 wt % ML Ti₃C₂Tₓ-Al billets, the (002) and (006) peaks of Ti₃C₂Tₓ were identified (panels e through f, k, and l of FIG. 9). The appearance of Ti₃C₂Tₓ (002) peak in 10 wt % Ti₃C₂Tₓ indicate that the increase in MXene content leads to enough flake re-stacking to detect the (00 [symbol] ) peaks inside an aluminum matrix. SEM images (panels a through d of FIG. 19) reveal the differences in flake morphology between 5 and 10 wt % single-to-few layer Ti₃C₂Tₓ. In both samples, it is believed that restacking of Ti₃C₂Tₓ flakes occurs because Ti₃C₂Tₓ contents are higher than the needed single-flake-coverage as calculated previously (1.96 wt %). However, the restacked flakes in the single-to-few layer 5 wt % Ti₃C₂Tₓ in Al are relatively thin and less uniformly stacked as compared to the 10 wt % Ti₃C₂Tₓ in Al. The XRD² results of the multi-layer clay 5 wt % ML Ti₃C₂Tₓ-Al sheds light on the effect of stacked particles, in which the (002) and (006) are clearly detected (panels f and k of FIG. 9). The detection of the (00 [symbol] ) peaks only in multi-layer 5 wt % Ti₃C₂Tₓ and 10 wt % Ti₃C₂Tₓ in Al indicates that (00 [symbol] ) peaks appear only when MXene formed ordered stacking of individual flakes. In addition, the small signal “dots” on the (110) Ti₃C₂Tₓ signal in the 60° 2θ focus of 5 wt % ML Ti₃C₂Tₓ-Al sample (FIG. 5e) likely is due to stacked layers of Ti₃C₂Tₓ in the particles of ML Ti₃C₂Tₓ (FIG. 20). The uniform crystalline particles are shown in XRD² scans, corresponding to Ti₃C₂Tₓ diffraction signal patterns, which appear as dots in XRD² patterns. In addition to the dots corresponding to the (110) peaks of Ti₃C₂Tₓ, the (109), (1012), (204), (205) peaks at 56.38°, 69.63°, 72.67°, 74.37° 2θ are seen as shown by the arrows (left to right, respectively) in panel r of FIG. 9 in the 5 wt % Ti₃C₂Tₓ -Al sample. These peaks can also be seen in Ti₃C₂Tₓ clay, as shown in FIG. 20 by the arrows. The SEM images of the 5 wt % ML Ti₃C₂Tₓ-Al samples show the multi-layer particles of MXene on Al particles instead of near complete coverage with MXene flakes (panels e and f of FIG. 19). Based on the XRD² results, it is believed that the (110) peaks of single-to-few layer MXene in a bulk matrix should be seen, and the (00 [symbol] ) peaks will not be seen.

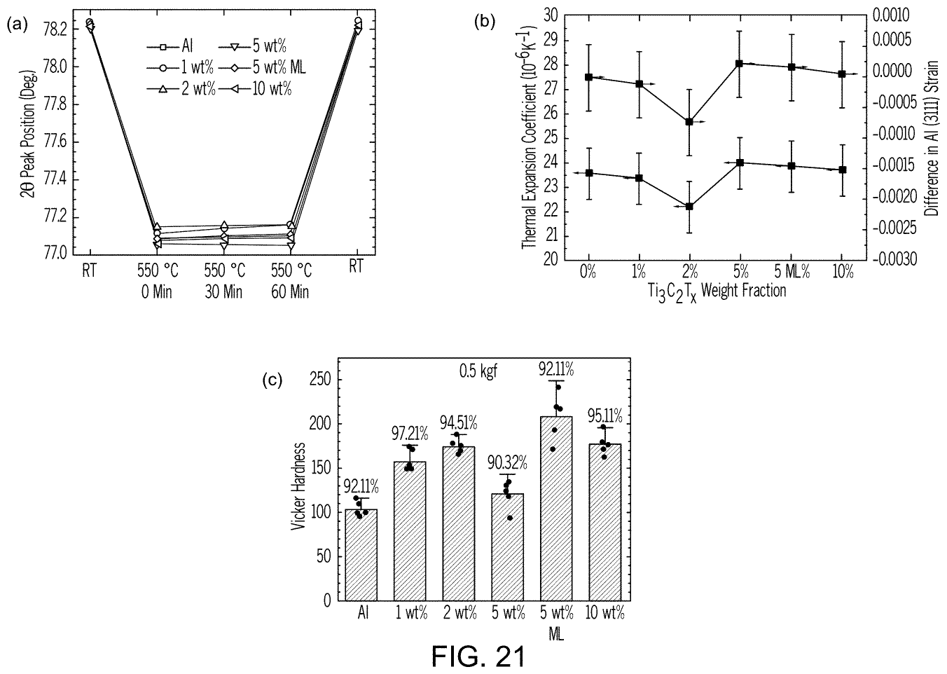

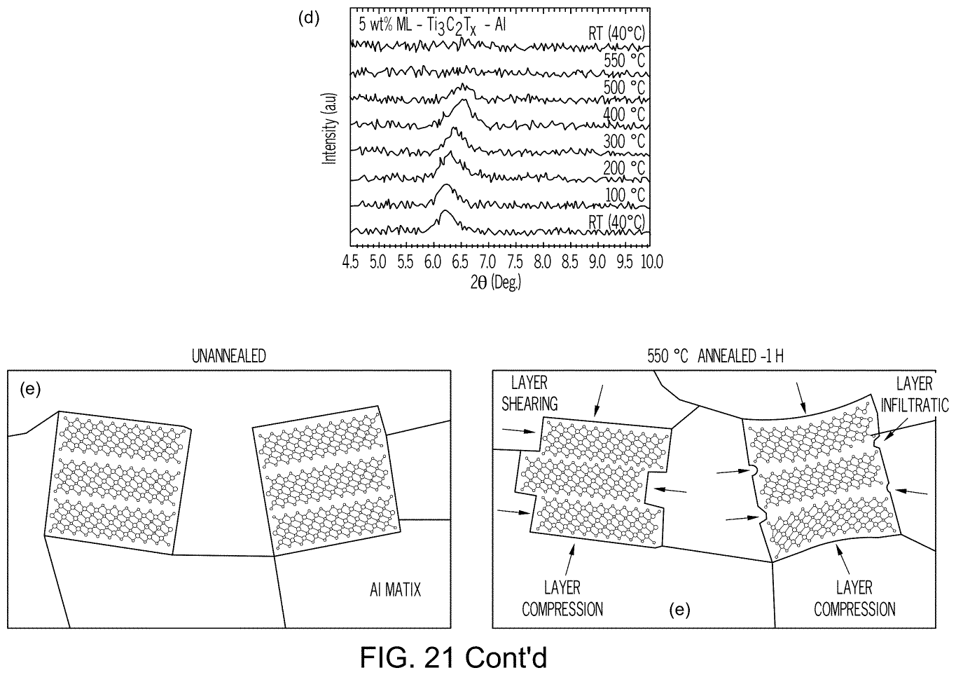

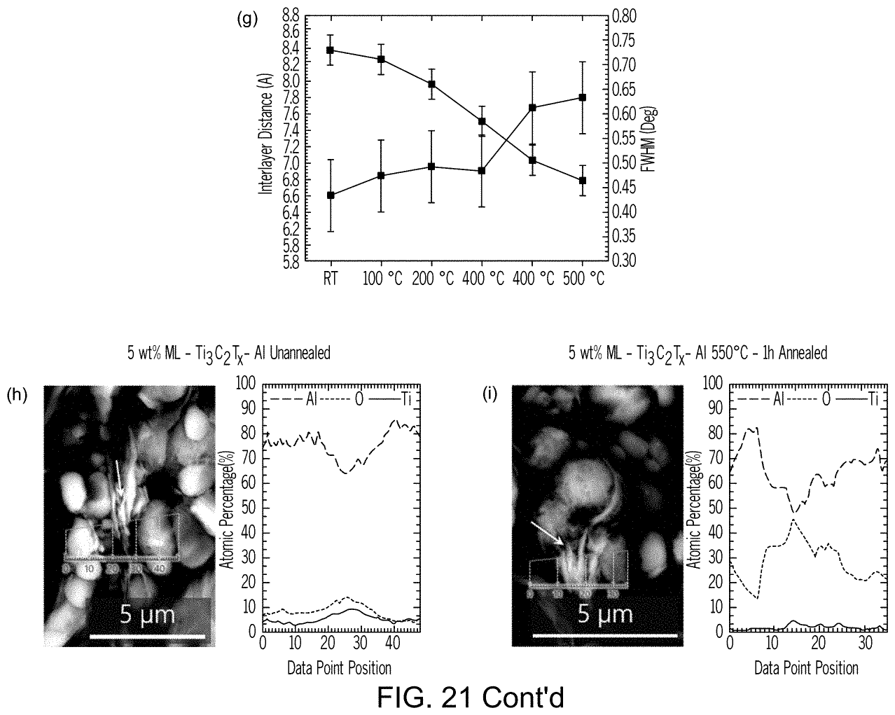

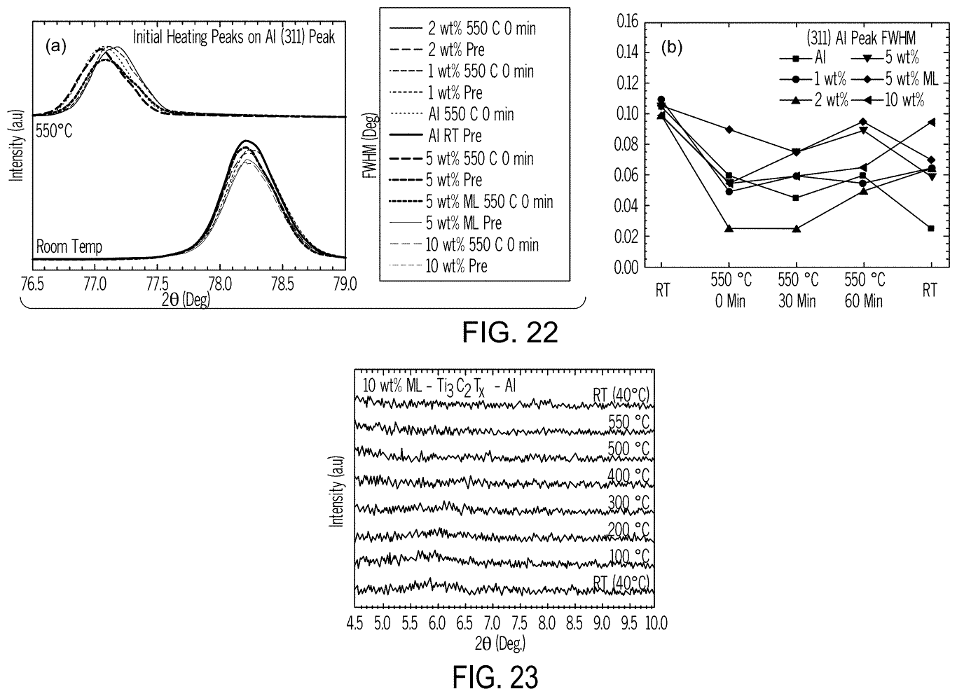

After gaining understanding of Ti₃C₂Tₓ XRD² pattern dependence on the morphology of Ti₃C₂Tₓ in the metal matrix, the response of Ti₃C₂Tₓ and Al billets was examined through analysis of XRD pattern peak shifting during in-situ hot stage XRD² annealing. To roughly represent currently used densification temperatures of Ti₃C₂Tₓ MXene in an Al matrix, room temperature compressed billet samples were annealed up to 550° C. on an AlN substrate in a domed in-situ hot stage in XRD and held at this temperature for 1 h in ambient conditions. To visualize more pronounced changes in the peak position of Al during in-situ annealing, the shifting of the (311) peak of Al was analyzed, as shown in panel a of FIG. 21 (with the raw pattern shown in panel a of FIG. 22). First, this peak shift was utilized to calculate the thermal expansion coefficient (TEC) of Al in the pure Al and the Al-Ti₃C₂Tₓ composites, as shown in panel B of FIG. 21. The (110) peak of Ti₃C₂Tₓ was not analyzed due its expectedly high thermal expansion coefficient as compared to Al. During this experiment, the Al control sample's TEC was controlled along the (311) plane in Al as 23.59±1.04×10⁻⁹ K⁻¹, which is in agreement with previous in-situ heated XRD studies on pure Al.

After establishing the baseline TEC for Al, the trends in the TEC for reinforced Al with Ti₃C₂Tₓ were next analyzed. The average TEC for Ti₃C₂Tₓ -Al composites decreased up to 22.19±1.04×10⁻⁶K⁻¹ for single-to-few layer 2 wt % reinforced Ti₃C₂Tₓ-Al. In general, decreases in the TEC of reinforced metal composites indicate mechanical reinforcement of the matrix since a lower TEC indicates prevention of the expansion of the matrix metal at increased temperatures. In order to ensure the lower TEC is due to reinforcement and not inherent grain growth phenomena of Al, the full-width at half maximum (FWHM) of the (311) peak of Al at 550° C. for 1 h was analyzed (panel b of FIG. 22), and it was noted that the FWHM of the Al (311) peak was within 0.01° 2θ. It was next noted that 5 and 10 wt % inclusion of single-to-few layer Ti₃C₂Tₓ and 5 wt % ML Ti₃C₂Tₓ in the Al matrix results in a similar or higher CTE of Al than that of pure Al. This can potentially be explained by the multi-layer nature of higher concentrations of Ti₃C₂Tₓ in Al. In previous atomic force microscopy (AFM) studies, Ti₃C₂Tₓ multi-layer flakes have shown to have very low inter-layer adhesion, especially at increased temperatures, which could result in inter-flake sliding during thermal expansion of the Al matrix during annealing. This inter-flake sliding could cause application of a small tensile strain on Al, as shown by the panel b of FIG. 21, as the inter-flakes of Ti₃C₂Tₓ slide past each other and result in a higher TEC for high loadings of Ti₃C₂Tₓ.

After analysis of the thermal behavior of all the composites and the pure Al sample, the Vickers microhardness testing was used to analyze the resultant mechanical properties of the billets after annealing at 550° C. for 1 h in the in-situ hot stage setup (panel c of FIG. 21) in air. To conduct the hardness testing, 5 to 6 indentations were collected with a diamond pyramidal indenter using a load of 0.5 kg force on a polished surface of each billet, the diagonal dimensions to the nearest micron was measured, the Vickers microhardness of each indentation was calculated, and the values were averaged to plot the bar graph with standard deviation, as shown in panel c of FIG. 21. For Al, the Vickers microhardness is roughly 104.07±8.31 HV, which agrees with previous studies on Al and Al composites using 0.5 kg force for Vickers testing. After establishing a baseline for pure Al, the results for the Ti₃C₂Tₓ-Al composites were next analyzed. For 1 and 2 wt % inclusion of single-to-few layer Ti₃C₂Tₓ in Al, an increasing Vickers hardness up to 175.80±8.32 HV was observed for 2 wt % single-to-few flake Ti₃C₂Tₓ -Al. However, at 5 wt % single-to-few flake Ti₃C₂Tₓ -Al, a decrease to 120.30±15.59 HV was observed. Without intending to be bound by any particular theory, it is believed that this decrease could be due to similar reasons as previous literature of graphene reinforced metal composites, where loosely bound flakes of graphene result in stress concentrations within the matrix leading to lowered mechanical strength of the composite material. However, a change in this established trend for the Vickers values of 177.22±12.15 HV and 208.36±26.69 HV for 10 wt % single-to-few flake Ti₃C₂Tₓ-Al and 5 wt % multi-layer flake Ti₃C₂Tₓ-Al composites, respectively, was observed. It is possible that the difference in this trend as compared to established literature could be due to the stacking of Ti₃C₂Tₓ flakes in Al, as noted by the presence of (00 [symbol] ) peaks of Ti₃C₂Tₓ. An analysis of the evolution of the stacking of Ti₃C₂Tₓ during annealing using in-situ XRD² methods was performed.

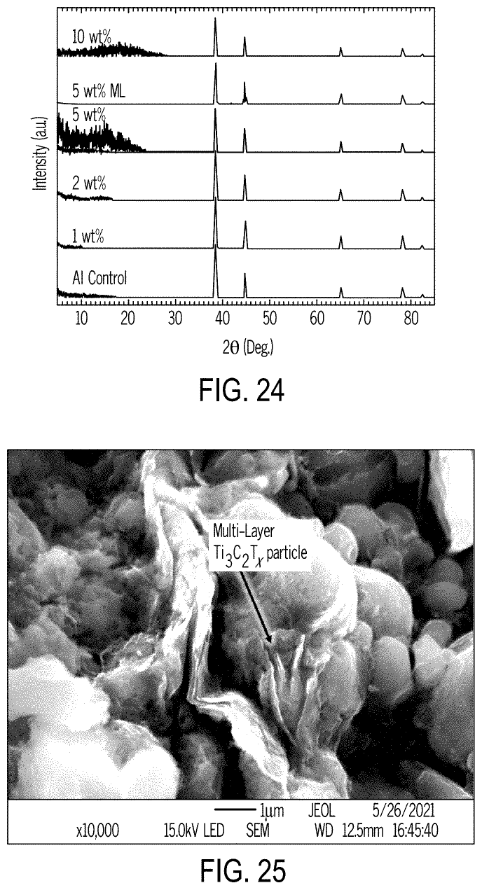

To understand how the (00 [symbol] ) peaks of 10 wt % single-to-few flake and 5 wt % multi-layer flake Ti₃C₂Tₓ in Al change during annealing, scans were again focused at 10° 2θ (0 to 25°) and scanned during in-situ XRD² annealing from room temperature (taken at 40° C.) up to 550° C. in ambient conditions at increments of 100° C. The XRD spectra for 5 wt % multi-layer flake Ti₃C₂Tₓ in Al are shown in panel d of FIG. 21. In both 10 wt % single-to-few flake and 5 wt % multi-layer flake Ti₃C₂Tₓ-A1, the (002) peak of Ti₃C₂Tₓ slowly broadens and right-shifts until it is unintelligible from the signal noise. Only 5 wt % multi-layer flake Ti₃C₂Tₓ in Al is discussed here as the peaks are more intense, likely due to its higher order of stacking as it was not fully delaminated, but the similar trend in (002) peak of Ti₃C₂Tₓ in 10 wt % single-to-few flake Ti₃C₂Tₓ during annealing is shown in FIG. 23. After visualizing the trend in the (002) peak changes during increasing annealing temperatures, it was believed that the loss of the (002) peak was due to changes in the morphology of the Ti₃C₂Tₓ stacks of flakes, as previous literature did not see phase transformations of Ti₃C₂Tₓ itself or Ti₃C₂Tₓ in Al until 700° C. or beyond. All full spectrum diffractograms of pre- and post-annealed single-to-few flake and multi-layer flake Ti₃C₂Tₓ in Al are shown in FIG. 24. Without intending to be bound by any particular theory, it is believed that the changes in morphology could be due to two mechanisms, as shown in panels e and f of FIG. 21. The loss of (002) peaks in Ti₃C₂Tₓ could be due to interlayer shearing of Ti₃C₂Tₓ layers due to the compressive force placed on the stacks, as has been previously witnessed in AFM experiments, and/or due to partial Al infiltration in between the stacks of Ti₃C₂Tₓ layers during annealing, which has been suggested in previous studies of Ti₃C₂Tₓ in Al using transmission electron microscopy methods. Regardless of the exact mechanism, the annealing of stacked Ti₃C₂Tₓ in Al appears to alter the morphology of the Ti₃C₂Tₓ stacks, as evidenced by the decreasing interlayer distance and increasing FWHM as evidenced by analysis of the (002) peak position and shape, as shown in panel g of FIG. 21. This morphology alteration appears to result in a change in the mechanical properties of the bulk composite, as the Vickers hardness values of the annealed 5 wt % ML Ti₃C₂Tₓ in Al is 73% higher than that of 5 wt % single-to-few flake Ti₃C₂Tₓ in Al.

After using in-situ XRD² methods to analyze the changes in the (002) peak of 5 wt % ML Ti₃C₂Tₓ in Al, SEM and EDS line-scan methods were used to characterize the structure of the multi-layer Ti₃C₂Tₓ both pre- and post-annealing. To prepare these samples for SEM and EDS analysis, the specimen was fractured and the cross-sectional fracture surface was investigated to visualize the multi-layers of Ti₃C₂Tₓ. In order to find the multi-layers of Ti₃C₂Tₓ, a backscatter electron detection mode was used, noting the brighter features which appeared like multi-layer Ti₃C₂Tₓ in the images since Ti is a heavier element than Al. After locating these brighter features with layered appearance of multi-layer Ti₃C₂Tₓ in the fractured cross-section of the non-annealed billet, EDS line-scan analysis across the cross-section of the multi-layer Ti₃C₂Tₓ (as marked by the white arrow) was then used to establish the baseline EDS spectrum for the cross-section of multi-layer Ti₃C₂Tₓ embedded in Al. As shown in panel h of FIG. 21, the signal attributed to the atomic percentage of Al decreases from roughly 80% to 65% in accordance with an increase in signal attributed to the atomic percentage of Ti from roughly 0-1% to 9% as the line-scan traverses across the cross-section of Ti₃C₂Tₓ. This atomic percentage of each element then returns back to previous atomic percentage values once the line-scan traverses past the multi-layer cross-section of Ti₃C₂Tₓ. In addition, the increase in atomic percentage of 0 across the cross-section of multi-layer Ti₃C₂Tₓ can be attributed to the O-containing surface groups of Ti₃C₂Tₓ.

After establishing a baseline EDS line-scan spectrum for the cross-section of multi-layer Ti₃C₂Tₓ embedded in Al when compressed at room temperature, a similar SEM with EDS line scan of a multi-layer Ti₃C₂Tₓ in a 5 wt % ML Ti₃C₂Tₓ-Al annealed at 550° C.—1 h (panel i of FIG. 21) was conducted. When using backscatter imaging on this cross-section, the Ti₃C₂Tₓ stacked particle appeared different in morphology, where clear “fingers” extend out of the stacked Ti₃C₂Tₓ particle as marked by the arrow. In the EDS line scan, the Ti₃C₂Tₓ signal rises from a baseline of roughly 1% atomic composition of Ti up to 4.4% while the Al signal decreases from a pre-multi-layer particle baseline of roughly 57% to 44% as the “fingers” point of the multi-layer Ti₃C₂Tₓ particle is reached.

The lower atomic composition of Ti across the monolayer is partly related to the resolution of the EDS line-scan, as each data point along the line has a resolution of roughly 0.1 μm, which is well below the thickness of an individual flake of Ti₃C₂Tₓ. However, without intending to be bound by any particular theory, it is believed that the lower concentration of Ti is due to this “finger” effect, as it does not appear like a solid multi-layer particle anymore in backscatter electron detection mode, which likely would decrease the available Ti signal. This is likely not due to the fracture surface or Al above the multi-layer Ti₃C₂Tₓ particle, as the multi-layer Ti₃C₂Tₓ particle can be seen to be clearly exposed above the Al matrix in a secondary electron image as shown in FIG. 25. After the Ti signal peaks at roughly 4.4%, the Ti atomic composition decreases down to 2% while the Al peak increases to 63% as scan continues across the dark portion of the backscatter micrograph between data points roughly 18-20. After reaching the bright portion of the backscatter image at position 24, the Ti content peaks again to 3.4% before it decreases again after the brighter portion of the micrograph. In addition to the trend in Ti atomic composition peak, the O atomic composition peaks at similar locations to that of Ti, which may indicate local oxidation at the interface between Ti₃C₂Tₓ and Al, as seen in previous studies indicating formation of Al₂O₃ occurs the interface of annealed Ti₃C₂Tₓ and Al.

The alternation between peaking Ti and O atomic compositions and the inverse in Al signal, the lower relative Ti atomic composition as compared to non-annealed billets, and the “finger” like features in the backscatter electron SEM imaging of the multi-layer Ti₃C₂Tₓ particles in the annealed 5 wt % ML Ti₃C₂Tₓ-Al composite suggest that the loss of the (002) Ti₃C₂Tₓ diffraction peak in both 5 wt % ML Ti₃C₂Tₓ and 10 wt % single-to-few layer Ti₃C₂Tₓ in Al is due to morphological changes in the stacked Ti₃C₂Tₓ during annealing of the composite mixture seen in both pre-stacked multi-layer Ti₃C₂Tₓ and re-stacked single-to-few layer Ti₃C₂Tₓ. It is possible that the increase in Vickers Micro-Hardness for these specific composites could be due to these morphological changes in these stacked Ti₃C₂Tₓ flakes. The potential strengthening mechanism of these altered stacked Ti₃C₂Tₓ flakes could be due to the increased available surface area in contact with Al for stress transfer and/or due to increased ability to block dislocation motion during plastic deformations in Al with these reaching “fingers” of Ti₃C₂Tₓ. The increased reinforcement potential of multi-layer stacked Ti₃C₂Tₓ particles at higher concentrations of Ti₃C₂Tₓ in the Al matrix is a uncommon phenomena to other nanomaterials and could provide further evidence of the reinforcing capabilities MXene has for future metal matrix composites.

Described above is a self-assembly process of Ti₃C₂Tₓ to aluminum which can be tuned to create single-to-few layer dispersions of Ti₃C₂Tₓ flakes from 1 to 5 wt %. In addition, this same process can be used to include pre-stacked multi-layers of Ti₃C₂Tₓ at 5 wt % or result in re-stacking of multi-layers of single-to-few flakes of Ti₃C₂Tₓ at concentrations above 5 wt %. The ability to achieve near-full coverage of Al by Ti₃C₂Tₓ can be used to create a network of Ti₃C₂Tₓ in the Al matrix which can be used for multi-functional structural and/or conductive metal composites. This self-assembly process is also shown to be scalable to form large batches of Ti₃C₂Tₓ-Al powder, which makes this process advantageous for future additive manufacturing of bulk Ti₃C₂Tₓ-Al metal composites. Additionally, XRD² has been established as a powerful tool to detect small amounts of MXene in a bulk metal matrix as low as 1 wt %. Furthermore, the use of XRD² to detect single-to-few layer dispersions versus multi-layer dispersions of MXene and analyze MXene's effects on the Al matrix as well as the morphological changes in MXene during annealing with in-situ methods will be helpful to further developments of bulk metal composites utilizing MXene for various applications.

### Experimental Details

### Ti₃C₂Tₓ Synthesis

The Ti₃C₂Tₓ is synthesized from 4 g of its precursor MAX phase Ti₃AlC₂ through selective etching of Al via an acidic mixture using 12 mL of 48% HF solution (Sigma-Aldrich), 72 mL of 37% HCl solution (Sigma-Aldrich), and 36 mL of de-ionized H₂O. The acidic mixture is placed into a high-density polyethylene (HDPE) container with a magnetic Teflon-coated stir bar placed in an oil bath on a Corning 6795-620D Digital Stirring Hot Plate. The Ti₃C₂Tₓ is then slowly placed into the acid over a 3 min period, then mixed at 300 RPM at 35° C. for 24 h. After this period, the exfoliated Ti₃C₂Tₓ in an acidic solution is repeatedly washed with DI water via centrifugation in a 175 mL Falcon® Conical Centrifuge Tube in an Eppendorf centrifuge with a S-4-72 rotor at 2380 RPM for 5 min until the supernatant reaches a pH of 6. After acid washing, the Ti₃C₂Tₓ is delaminated using 4 g of anhydrous LiCl (Sigma-Aldrich) in 200 mL of DI water in a HDPE container with a Teflon-coated stir bar in an oil bath for 1 h at 1000 RPM at a temperature of 65° C. After delamination, the solution is washed three times at 14,000 RPM in 50 mL Fisher Scientific centrifuge tube in a Thermo-Fisher ST16 Centrifuge using a Fiberlite F15-8x50cy rotor for 5 minutes, 10 min, and 20 min for the first, second, and third washes, respectively. After this step, the dispersed Ti₃C₂Tₓ solution is centrifuged at 2380 RPM for 30 min, where the supernatant of this cycle is used as the delaminated, large-flake Ti₃C₂Tₓ solution. Multi-layer (clay) Ti₃C₂Tₓ was achieved through use of the clay-like sediment of this last 2380 RCF for 30-minute cycle. The concentration of the supernatant is determined by vacuum-assisted filtration of 10 mL of solution, overnight drying in a vacuum oven at 60° C., then weighing of the final free-standing Ti₃C₂Tₓ film.

To test the quality of the Ti₃C₂Tₓ batches used in the composites, this film was tested using a four-point probe setup using a Keithley 2400 SMU. The probe tips were separated in a measured 1 cm by 1 cm square on the surface of the Ti₃C₂Tₓ film to measure the resistance of the surface. After measuring the resistance, the thickness of the film was measured using a Holite digital micrometer (Part No. 4354523152). The thickness of the films was normally in the range of 50 μm thick. The conductivity of these films was calculated using the resistance and film thickness, which was typically >10,000 S·cm⁻¹.

The zeta measurements for Ti₃C₂Tₓ were conducted using a Malvern Zetasizer Nano Series using a fresh Malvern DTS1070 folded capillary zeta cell. The Ti₃C₂Tₓ was diluted in water to 0.1 mg mL⁻¹ and then shaken before the addition of 0.5 mL of the Ti₃C₂Tₓ water solution to the capillary zeta cell. The cell was then inserted into the Zetasizer Nano to measure in 3 cycles of 15 measurements with a 60 second delay between each cycle.

### Preparation of Al Flakes

Al flakes with freshly exposed non-oxidized Al layers were prepared by placing 5 g of Al spherical powder (Alfa-Aesar Catalog No. AA4100018) in 125 mL of 200 proof ethanol (Decon Labs, CAS 64-17-5,7732-18-5) into HDPE container for a final Al concentration of 40 mg mL⁻¹. Yttria-stabilized zirconia balls (10 mm) were added to the mixture at a ball-to-powder ratio by mass of 40:1. The entire assembled container was sealed with 99.9% Ar for 10 minutes by bubbling Ar into the Al in ethanol solution followed by sealing the lid with Parafilm (Parafilm M Bemis Catalog No. P6543). The assembled container is then placed in a rotating jar ball mill at an incline of 45° with respect to the axial direction and rotated at 64 RPM in a Shimpo PTA-02 Jar Mill for 24 h. Alternate BPR and milling times were completed similarly, with the only differences in the total mass of the Yttria-stabilized zirconia balls and the milling times, respectively.

The zeta measurements for Al were conducted after ball milling using a Malvern Zetasizer Nano Series using a fresh Malvern DTS1070 folded capillary zeta cell. 1 mL of ethanol containing 40 mg of Al was added to 10 mL glass vials, then the corresponding vol % water was added to each glass vial to gain a range of water vol % from 40 vol % to 80 vol %. Each vial was then shaken before the addition of 0.5 mL of the Al water-ethanol solution to the capillary zeta cell. Between each solution, the interior of the capillary zeta cell was thoroughly washed with a 70 vol % ethanol spray bottle (−50 mL) and emptied before the addition of the next Al water-ethanol solution. The cell was then entered in the Zetasizer Nano to measure in 3 cycles of 15 measurements with a 60 second delay between each cycle.

### Preparation and Treatment of Ti₃C₂Tₓ MXene—Al Powder

To prepare the Ti₃C₂Tₓ-aluminum mixture, 1 g of the dispersed ball milled Al in ethanol solution is added to a glass flask with a Teflon-coated magnetic stir bar on a stir plate. After adding aluminum, DI water is then added to the flask just below the corresponding to the vol % of water necessary in the water-ethanol solution(with accounting to the water in the to-be-added Ti₃C₂Tₓ-water solution). After mixing for two minutes, the 2 wt % of Ti₃C₂Tₓ is added from its water based solution to raise the overall water-ethanol concentration to 60 vol % de-ionized water (the 70 vol % sample was similarly completed to 70 vol % water addition). The Ti₃C₂Tₓ solutions were typically —5 mg·mL⁻¹ in concentration, so ˜34 mL pure DI water was added to the

Al ethanol solution before adding ˜4 mL of the Ti₃C₂Tₓ solution to achieve 2 wt % Ti₃C₂Tₓ in Al in a water-ethanol solution at 60 vol % concentration of water. The solution is then mixed at 1000 RPM for 10minutes at room temperature until a separation of MXene-Al precipitate slurry and clear solution is seen. The stirring is then stopped, and the solution is then left to settle.

The clear solution is then removed via pipetting and the remaining slurry is filtered via vacuum-assisted filtration with 2.5 μm pore diameter filter paper (Whatman). For non-clear solution (fully adsorbed) batches of Ti₃C₂Tₓ, the solution was left for 2 minutes and was then filtered without pipette-based removal of the solution. The control Al samples were similarly processed, without pipette-based removal of the solution. During filtration, the filtered powder is thoroughly washed by a spray bottle filled with 200 proof ethanol to remove any remaining water. After filtration of each mixed powder, the damp powder is dried >100° C. in a vacuum oven overnight. The larger batch of Ti₃C₂Tₓ-Al mixture was completed similarly to the 1 g batch, with the addition of 4 g Al total to the glass flask followed by the addition of 2 wt % Ti₃C₂Tₓ. The clear solution was removed via pipette and then filtered and dried according to the previously established methods.

### Characterization of Ti₃C₂Tₓ MXene—Al Powder

Dispersion of Ti₃C₂Tₓ within the Al powder is analyzed via field-emission scanning electron microscopy (FESEM) using a JEOL JSM-7800f FESEM with a lower electron detector at an acceleration voltage of 5 kV. All powder samples were coated with Au via sputtering to improve the conduction path of electrons for sharper images. The presence of Ti₃C₂Tₓ is determined by the differences in the flake morphology, where determination Ti₃C₂Tₓ is concluded by the existence of “folds” in the flake arrangement. The composition is further analyzed using a Bruker D8 x-ray diffractometer with Cu Kα (λ=1.5406 Å) emitter with a VANTEC 500 detector. The focused scans were conducted via centered scans at 10° and 60° 2θ using a still emitter/detector method for 15 minutes total. The long exposure still scan at 10° 2θ was similarly completed using a 60-minute total scan time. The full spectrum was captured using a paired emitter/detector movement program in a stepwise method with steps centered at 5° to 75° 2θ in increments of 5° 2θ for each step with a timestep of 60 s per step. The corresponding XRD² data is analyzed via merged detector images as well as a full-spectrum integration scheme in the DIFFRAC.SUITE EVA software to calculate traditional XRD plots. Traditional OD XRD scans were conducted using a Lynxeye XE detector with a step size of 0.02° 2θ with a dwell time of 24 seconds per step from 59° to 64° 2θ and was analyzed using the DIFFRAC.SUITE EVA software.

### Characterization of pressed Ti₃C₂Tₓ-Al Billets

Once dry, 300 mg of the Ti₃C₂Tₓ -Al powder was added to a boron nitride (BN) spray-coated (ZYP Boron Nitride Mold Primer, Model No. 3-1047-00-30) 13 mm diameter Cr₁₂MoV hardened steel die (Columbia International, Model No. CIT-LPD-SC13). The mixed powder was then compressed in the steel die at room temperature at 300 MPa for 5 min using a Carver 3889 Hydraulic Hot Press in ambient conditions. Once 5 min had passed, the billet was then removed from the mold. After pressing, the remaining boron nitride on the surface of the Ti₃C₂Tₓ-A1 pressed billet was removed through the use of 300 grit SiC sandpaper and was sanded until the exterior surface was removed. After BN removal, the density of the billet was measured using an Archimedes water immersion approach. After testing using this method, all billets were dried in the vacuum oven overnight at 100° C. Densification was calculated using an ideal density evaluated using the rule-of-mixtures approach with 4.2 g·cm³ and 2.7 g·cm³ for Ti₃C₂Tₓ and Al, respectively.

For in-situ XRD² characterizations, the Ti₃C₂Tₓ -Al billets were once-again sanded with 300 grit SiC sandpaper to remove any traces of oxides on the surface from the Archimedes density testing before they were affixed to an AlN substrate using stainless steel pins at the edges of the billets within an Anton-Parr DHS 1100 domed hot stage. After affixing the sample on the substrate, a protective graphite dome was placed over the samples. The test on the (311) peak of Al was conducted by focusing the scan at 75° 2θ and scanning for 60 s per step. The test for the (311) peak of Al was started at room temperature (taken as 40° C., as the actual room temperature in this lab fluctuated around 28-31° C.) before ramping up to 550° C. at a ramp rate of 60° C./min and taking scans once 550° C. was reached (taken as 0 min), 30 minutes after 550° C. was reached (taken as 30 min), and after 1 h 550° C. was reached (taken as 60 min) before rapid cooling using forced air convection over the surface of the protective graphite dome at a roughly averaged cooling rate of 30-40° C./min. After 40° C. was reached again, another scan was taken before removing the billet from the hot stage apparatus. A similar experimental setup was taken to analyze the (00 [symbol] ) peaks of 10 wt % single-to-few flake and multi-layer flakes of Ti₃C₂Tₓ in Al, but the scan was focused at 5° 20θ for 60 s/step while the temperature was ramped up at a rate of 60° C./min to 100° C., 200° C., 300° C., 400° C., 500° C., and 550° C. with a scan taken at each of these temperature points before ramping to the next temperature. After 550° C. was reached, the stage was once again cooled to 40° C. at a roughly averaged 30-40° C./min before another scan was taken. After removal from the hot stage setup, the density of the billet was again measured using an Archimedes water immersion approach.

After the in-situ hot stage annealing tests were conducted, the billets were then removed and sanded slowly up to 1800 grit sandpaper to make a fairly smooth surface for Vickers Micro-Hardness testing. Vickers Micro-Hardness testing was conducted using a Phase II Micro Vickers Hardness Tester (Model No: 900-390) equipped with a pyramidal indenter using a 0.5 kg (4.9 N) indentation force with a dwell time of 15 s. To take repetitive tests, the indenter was moved at least 2 mm away from the previous test before the next indentation was taken. The Vickers Micro-Hardness was calculated using an average of the two distances between opposite corners in the square pyramidal indentation.

After Vickers Micro-Hardness testing, the non-annealed and annealed 5 wt % ML Ti₃C₂Tₓ samples were prepared for fracture cross-section SEM/EDS analysis through physically breaking the billet with pliers before they were mounted onto the side of a SEM stage using double-sided amorphous carbon tape for analysis. To ensure the EDS data was not affected by this SEM stage, the exposed fractured cross-section was raised approximately 1 mm above the stage before securement. SEM backscatter images were taken at a working distance of 12 mm from electron probe with an acceleration voltage of 15 kV. EDS line-scan was conducted across a length of 3.5-4.0 μm with a point taken at approximately every 0.1 μm using the default “high” quality scan with an EDAX octane super detector and was subsequently analyzed for atomic composition using the EDAX TEAM software.

### Preparation and Treatment of Ceramic-MXene Green Bodies

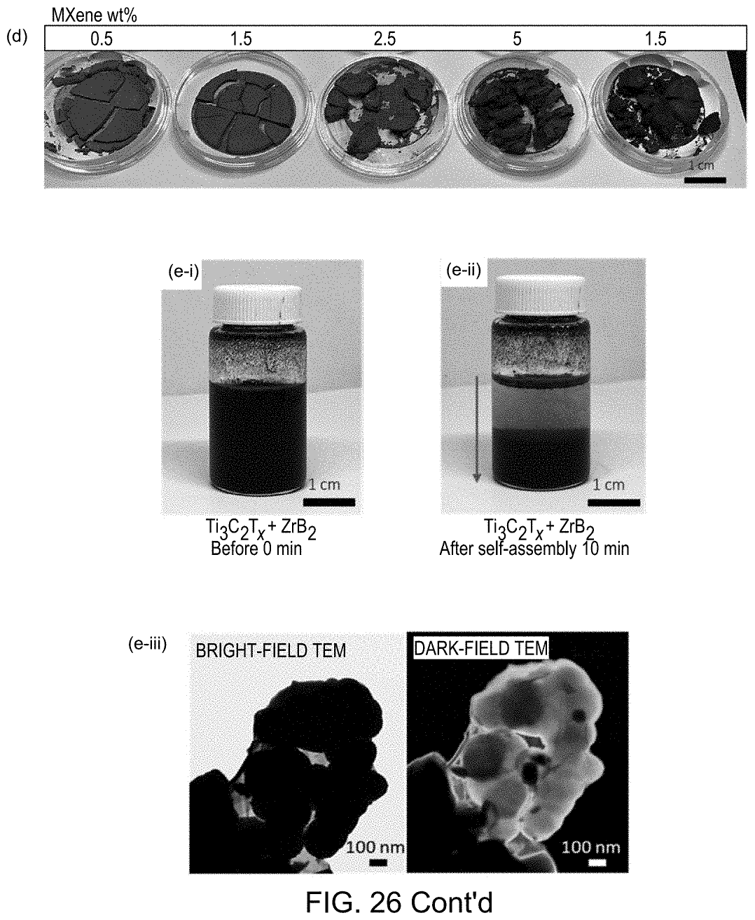

Panel (a) of FIG. 26 shows the zeta-potential values of various oxides namely, zinc oxide, aluminum oxide, and zirconium oxide. Panel (b) of FIG. 26 represents the zeta-potential values of zirconium diboride, silicon carbide, and zirconium carbide at pH 5. Panel (c) of FIG. 26 shows the deviation in zeta-potentials of a mixture of ceramic powders, namely-zirconium diboride and silicon carbide, between a pH range from pH 2 to pH 7.

The embodiment used as proof of concept is zirconium diboride powders (ZrB₂) and a mixture of ZrB₂ and SiC powders. To prepare the mixture, 1 g of ceramic powders were mixed in 15 ml of pH 5 de-ionized water. These ceramic slurries were sonicated for 1 hour in a bath sonicator. The prepared slurries were then added dropwise at a rate of ˜100 mg/min to a MXene solution adjusted to pH 5 under constant magnetic stirring. These mixtures were then stirred continuously for 1 hour at 300-800 RPM speeds until a separation of precipitate slurry and clear solution was seen. The stirring was then stopped, and the solution was then left to settle. The clear solution was first removed via pipetting and the remaining slurry was filtered via vacuum-assisted filtration with 0.8 μm pore diameter filter paper. Panel (d) of FIG. 26 shows the dried-self-assembled ZrB₂-MXene powders with various MXene wt % (0.5 to 15 wt %). Panel (e) of FIG. 26 shows the vials containing mixtures of ceramic-MXene before and after self-assembly process between ZrB₂ and MXene and the transmission electron microscopy (TEM) images in bright filed and dark-field modes showing the ceramic grain covered by flakes of MXene.

### Preparation and Treatment of Ceramic-MXene Green Bodies

The ZrB₂-MXene powders were analyzed via field-emission scanning electron microscopy (FESEM) using a JEOL JSM-7800f FESEM with a transmission electron detector at an acceleration voltage of 30 kV, and a probe current of 4 A. The presence of Ti₃C₂Tₓ is determined by the differences in the transparencies of the images, where determination of Ti₃C₂Tₓ is concluded by the existence of “sharp contrast” between the transparent MXene sheets and the opaque ceramic grains, as shown in panel (e) of FIG. 26.

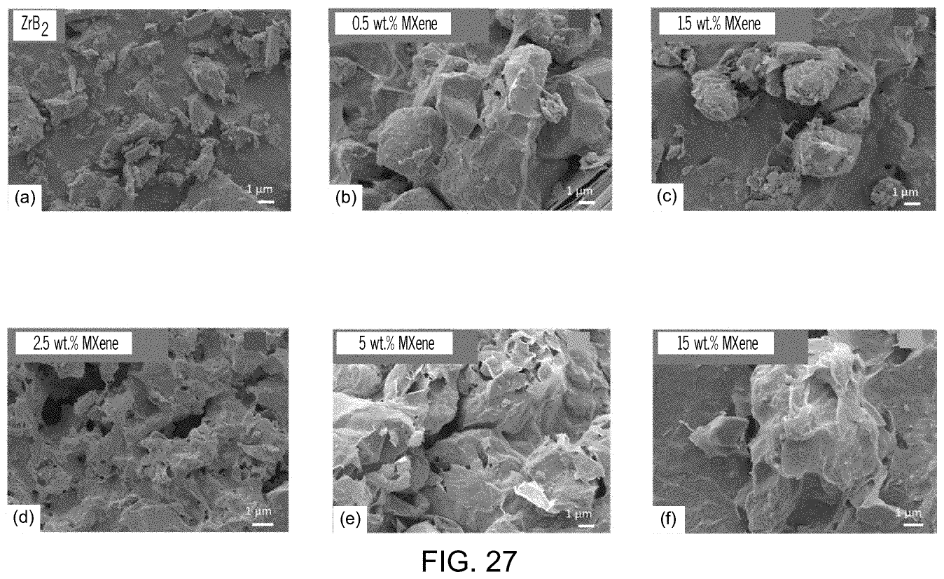

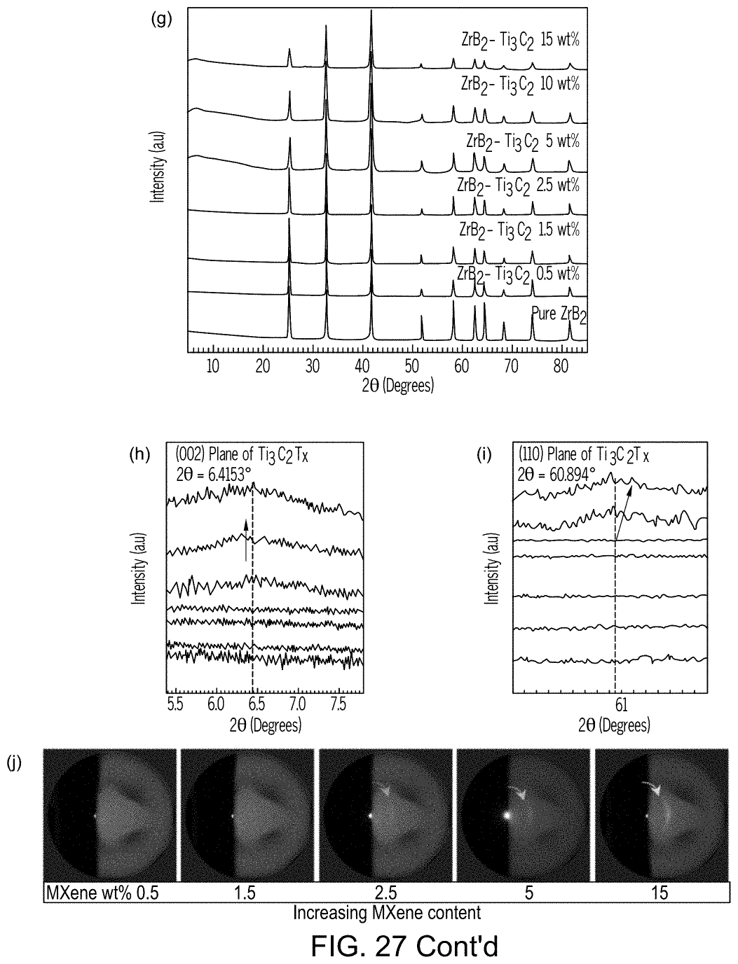

Dispersion of Ti₃C₂Tₓ within the ZrB₂ powder is also analyzed via field-emission scanning electron microscopy (FESEM) using a JEOL JSM-7800f FESEM with a lower electron detector at an acceleration voltage of 5 kV. All powder samples were coated with Au via sputtering to improve the conduction path of electrons for sharper images, as shown in panels (a) through (f) of FIG. 27. The composition of the powders were further analyzed using a Bruker D8 x-ray diffractometer with Cu Kα (λ=1.5406 Å) emitter with a VANTEC 500 detector (see panels (g) through (i) of FIG. 27). The focused scans were conducted via centered scans at 10° and 60° 2θ using a still emitter/detector method for 15 minutes total. The long exposure still scan at 10° 2θ was similarly completed using a 60-minute total scan time. The full spectrum was captured using a paired emitter/detector movement program in a stepwise method with steps centered at 5° to 75° 2θ in increments of 5° 2θ for each step with a timestep of 60 s per step. The corresponding XRD² data is analyzed via merged detector images as well as a full-spectrum integration scheme in the DIFFRAC.SUITE EVA software to calculate traditional XRD plots. Traditional OD XRD scans were conducted using a Lynxeye XE detector with a step size of 0.02° 2θ with a dwell time of 24 seconds per step from 59° to 64° 2θ

A. K. G. K. S. Novoselov, S. V. Morozov, D. Jiang, Y. Zhang, S. V. Dubonos, I. V. Grigorieva, A. A. Firsov, “Electric Field Effect in Atomically Thin Carbon Films,” Science, Journal Article vol. 306, 10/2/2004 2004, doi: 10.1126/science.1102896.

M. Naguib et al., “Two-dimensional nanocrystals produced by exfoliation of Ti₃AlC₂,”AdvMater, vol. 23, no. 37, pp. 4248-53, Oct. 4 2011, doi: 10.1002/adma.201102306.

M. Ghidiu, Lukatskaya, M. R., Zhao, M. Q., Gogotsi, Y., Barsoum, M. B., “Conductive two-dimensional titanium carbide ‘clay’ with high volumetric capacitance,” Nature, vol. 516, pp. 78-81, 26 Nov. 2014 2014.

D. Pinto et al., “Synthesis and electrochemical properties of 2D molybdenum vanadium carbides—solid solution MXenes,” Journal of Materials Chemistry A, vol. 8, no. 18, pp. 8957-8968, 2020, doi: 10.1039/dota01798a.

T. Mathis, Maleski, K., Goad, A., Sarycheva, A., Anayee, M., Foucher, A. C., Hantanasirisakul, K., Stach, E., Gogotsi, Y., “Modified MAX Phase Synthesis for Environmentally Stable and Highly Conductive Ti₃C₂ MXene,” ACS Nano, vol. 15, pp. 6420-6429, 2021.

Y. Li et al., “A general Lewis acidic etching route for preparing MXenes with enhanced electrochemical performance in non-aqueous electrolyte,” Nat Mater, vol. 19, no. 8, pp. 894-899, August 2020, doi: 10.1038/s41563-020-0657-0.

V. Kamysbayev, Filatov, A. S., Hu, H., Rui, X., Lagunas, F., Wang, D., Klie, R. F., Talapin, D. V., “Covalent surface modifications and superconductivity of two-dimensional metal carbide MXenes,” Science, 2 Jul. 2020 2020, doi: 10.1126/science.aba8311.

M. Li et al., “Element Replacement Approach by Reaction with Lewis Acidic Molten Salts to Synthesize Nanolaminated MAX Phases and MXenes,” J Am Chem Soc, vol. 141, no. 11, pp. 4730-4737, Mar. 20 2019, doi: 10.1021/jacs.9b00574.

M. A. Hope et al., “NMR reveals the surface functionalisation of Ti₃C₂ MXene,” Phys Chem Chem Phys, vol. 18, no. 7, pp. 5099-102, Feb. 21, 2016, doi: 10.1039/c6cp00330c.

Y. Gogotsi and B. Anasori, “The Rise of MXenes,” ACS Nano, vol. 13, no. 8, pp. 8491-8494, Aug. 27 2019, doi: 10.1021/acsnano.9b06394.

M. R. Lukatskaya et al., “Ultra-high-rate pseudocapacitive energy storage in two-dimensional transition metal carbides,” Nature Energy, vol. 2, no. 8, 2017, doi: 10.1038/nenergy.2017.105.

Y. Xia et al., “Thickness-independent capacitance of vertically aligned liquid-crystalline MXenes,” Nature, vol. 557, no. 7705, pp. 409-412, May 2018, doi: 10.1038/s41586-018-0109-z.

B. Anasori, M. R. Lukatskaya, and Y. Gogotsi, “2D metal carbides and nitrides (MXenes) for energy storage,” Nature Reviews Materials, vol. 2, no. 2, 2017, doi: 10.1038/natrevmats.2016.98.

Z. W. Seh et al., “Two-Dimensional Molybdenum Carbide (MXene) as an Efficient Electrocatalyst for Hydrogen Evolution,” ACS Energy Letters, vol. 1, no. 3, pp. 589-594, 2016, doi: 10.1021/acsenergylett.6b00247.

K. R. G. Lim et al., “Rational Design of Two-Dimensional Transition Metal Carbide/Nitride (MXene) Hybrids and Nanocomposites for Catalytic Energy Storage and Conversion,” ACS Nano, Aug. 31, 2020, doi: 10.1021/acsnano.0c05482.

J. Guo et al., “Cold Sintered Ceramic Nanocomposites of 2D MXene and Zinc Oxide,” Adv. Mater, vol. 30, no. 32, p. e1801846, August 2018, doi: 10.1002/adma.201801846.

X. Zhang, Z. Zhang, and Z. Zhou, “MXene-based materials for electrochemical energy storage,” Journal of Energy Chemistry, vol. 27, no. 1, pp. 73-85, 2018, doi: 10.1016/j.jechem.2017.08.004.

J. Zhang et al., “Scalable Manufacturing of Free-Standing, Strong Ti₃C₂Tₓ MXene Films with Outstanding Conductivity,” Adv Mater, p. e2001093, Apr. 20 2020, doi: 10.1002/adma.202001093.

Y. Li et al., “In Situ Tensile Testing of Nanometer-Thick Two-Dimensional Transition-Metal Carbide Films: Implications for MXenes Acting as Nanooscale Reinforcement Agents,” ACS Applied Nano Materials, 2021, doi: 10.1021/acsanm. 1c00537.

B. C. Wyatt, Rosenkranz, A., Anasori, B., “2D MXenes: Tunable Mechanical and Tribological Properties,” Adv Mater, vol. 33, no. 6, p. 2007973, 2021, doi: 10.1002/adma.202007973.

A. Lipatov, Lu, H., Alhabeb, M., Anasori, B., Gruverman, A., Gogotsi, Y., Sinitskii, A., “Elastic properties of 2D Ti₃C₂Tₓ MXene monolayers and bilayers,” Sci Adv, vol. 4, no. 6, pp. 1-7, 15 Jun. 2018 2018, doi: 10.1126/sciadv.aat0491.

A. Lipatov et al., “Electrical and Elastic Properties of Individual Single-Layer Nb₄C₃Tₓ MXene Flakes,” Advanced Electronic Materials, 2020, doi: 10.1002/aelm.201901382.

Y. Ul Haq et al., “Investigation of improved dielectric and thermal properties of ternary nanocomposite PMMA/MXene/ZnO fabricated by in-situ bulk polymerization,” Journal of Applied Polymer Science, vol. 137, no. 40, 2020, doi: 10.1002/app.49197.

J. Lipton et al., “Mechanically Strong and Electrically Conductive Multilayer MXene Nanocomposites,” Nanoscale, 2019, doi: 10.1039/c9nr06015d.

Y. J. Mai, Y. G. Li, S. L. Li, L. Y. Zhang, C. S. Liu, and X. H. Jie, “Self-lubricating Ti₃C₂nanosheets/copper composite coatings,” Journal of Alloys and Compounds, vol. 770, pp. 1-5, 2019, doi: 10.1016/j.jallcom.2018.08.100.

H. Zhang et al., “Preparation, mechanical and anti-friction performance of MXene/polymer composites,” Materials & Design, vol. 92, pp. 682-689, 2016.

J. Hu, S. Li, J. Zhang, Q. Chang, W. Yu, and Y. Zhou, “Mechanical properties and frictional resistance of Al composites reinforced with Ti₃C₂Tₓ MXene,” Chinese Chemical Letters, 2019, doi: 10.1016/j.cclet.2019.09.004.

V. Kamysbayev et al., “Colloidal Gelation in Liquid Metals Enables Functional Nanocomposites of 2D Metal Carbides (MXenes) and Lightweight Metals,” ACS Nano, Sep. 27 2019, doi: 10.1021/acsnano.9b06207.

Y. Sliozberg, J. Andzelm, C. B. Hatter, B. Anasori, Y. Gogotsi, and A. Hall, “Interface binding and mechanical properties of MXene-epoxy nanocomposites,” Composites Science and Technology, vol. 192, 2020, doi: 10.1016/j.compscitech.2020.108124.

M. Fei et al., “MXene-reinforced alumina ceramic composites,” Ceram. Int., vol. 43, no. 18, pp. 17206-17210, 2017.

H. Qing, D. U. Shi-Yu, D. Qi-Huang, C. Fan-Yan, and S. I. Xiao-Yang, “Preparation and Property of MXene/Copper Alloy Composites,” Journal of Inorganic Materials, vol. 33, no. 6, 2018, doi: 10.15541/jim20170297.

J. Zhang, S. Li, S. Hu, and Y. Zhou, “Chemical Stability of Ti₃C₂ MXene with Al in the Temperature Range 500-700 degrees ° C.,” Materials, vol. 11, no. 10, Oct. 15 2018, doi: 10.3390/ma11101979.

W. Zhou, Z. Zhou, Y. Fan, and N. Nomura, “Significant strengthening effect in few-layered MXene-reinforced Al matrix composites,” Materials Research Letters, vol. 9, no. 3, pp. 148-154, 2020, doi: 10.1080/21663831.2020.1861120.

M. Li, S. Wang, Q. Wang, F. Ren, and Y. Wang, “Preparation, microstructure and tensile properties of two dimensional MXene reinforced copper matrix composites,” Materials Science and Engineering: A, vol. 803, 2021, doi: 10.1016/j.msea.2020.140699.

B. C. Wyatt, S. K. Nemani, and B. Anasori, “2D transition metal carbides (MXenes) in metal and ceramic matrix composites,” Nano Convergence, vol. 8, no. 1, p. 16, Jun. 2 2021, doi: 10.1186/s40580-021-00266-7.

B. C. Wyatt, Nemani, S. K., Desai, K., Kaur, H., Zhang, B., Anasori, B., “High-Temperature Stability and Phase Transformations of Titanium Carbide (Ti₃C₂Tₓ) MXene,” Journal of Physics: Condensed Matter, vol. 33, 2021, doi: 10.1088/1361-648X/abe793

D. R. Forrest, Jasiuk, I., Brown, L., Joyce, P., Mansour, A., Salamanca-Riba, L., “Novel Metal-Matrix Composites with Integrally-Bound Nanoscale Carbon,” Naval Surface Warfare Center, 2012.

T. Knych, G. Kiesiewicz, P. Kwasniewski, A. Mamala, B. Smyrak, and A. Kawecki, “Fabrication and Cold Drawing of Copper Covetic Nanostructured Carbon Composites/Otrzymywanie Oraz Ciagnienia Kompozytów Miedzianych Typu Covetic O Strukturze Nanometrycznej,” Archives of Metallurgy and Materials, vol. 59, no. 4, pp. 1283-1286, 2014, doi: 10.2478/amm-2014-0219.

M. Cao et al., “Ultrahigh Electrical Conductivity of Graphene Embedded in Metals,” Advanced Functional Materials, vol. 29, no. 17, 2019, doi: 10.1002/adfm.201806792.

D. Lin, C. Richard Liu, and G. J. Cheng, “Single-layer graphene oxide reinforced metal matrix composites by laser sintering: Microstructure and mechanical property enhancement,” Acta Materialia, vol. 80, pp. 183-193, 2014, doi: 10.1016/j.actamat.2014.07.038.

Z. Hu et al., “Laser additive manufacturing bulk graphene-copper nanocomposites,” Nanotechnology, vol. 28, no. 44, p. 445705, Nov. 3 2017, doi: 10.1088/1361-6528/aa8946.

T. D. Ngo, A. Kashani, G. Imbalzano, K. T. Q. Nguyen, and D. Hui, “Additive manufacturing (3D printing): A review of materials, methods, applications and challenges,” Composites Part B: Engineering, vol. 143, pp. 172-196, 2018, doi: 10.1016/j.compositesb.2018.02.012.

D. Herzog, V. Seyda, E. Wycisk, and C. Emmelmann, “Additive manufacturing of metals,” Acta Materialia, vol. 117, pp. 371-392, 2016, doi: 10.1016/j.actamat.2016.07.019.

M. Ghidiu and M. W. Barsoum, “The {110} reflection in X-ray diffraction of MXene films: Misinterpretation and measurement via non-standard orientation,” Journal of the American Ceramic Society, vol. 100, no. 12, pp. 5395-5399, 2017, doi: 10.1111/jace.15124.

K. Maleski, V. N. Mochalin, and Y. Gogotsi, “Dispersions of Two-Dimensional Titanium Carbide MXene in Organic Solvents,” Chemistry of Materials, vol. 29, no. 4, pp. 1632-1640, 2017, doi: 10.1021/acs.chemmater.6b04830.

Z. Ling et al., “Flexible and conductive MXene films and nanocomposites with high capacitance,” Proc Natl Acad Sci USA, vol. 111, no. 47, pp. 16676-81, Nov. 25 2014, doi: 10.1073/pnas.1414215111.

Q. Liu, M. He, X. Xu, L. Zhang, and J. Yu, “Self-assembly of graphene oxide on the surface of aluminum foil,” New J. Chem., vol. 37, no. 1, pp. 181-187, 2013, doi: 10.1039/c2nj40493a.

Z. Li et al., “Uniform dispersion of graphene oxide in aluminum powder by direct electrostatic adsorption for fabrication of graphene/aluminum composites,” Nanotechnology, vol. 25, no. 32, p. 325601, Aug. 15, 2014, doi: 10.1088/0957-4484/25/32/325601.

J. Evertsson et al., “The thickness of native oxides on aluminum alloys and single crystals,” Applied Surface Science, vol. 349, pp. 826-832, 2015, doi: 10.1016/j.apsusc.2015.05.043.

U. P. Baoping Bob He, Kingsley L. Smith, “Fundamentals of Two-Dimensonal X-Ray Diffraction (XRD2),” Advances in X-ray Analysis, vol. 43, 2000.

B. He, Two-dimensional X-ray Diffraction. John Wiley & Sons, Inc., 2018.

C. E. Ren, K. B. Hatzell, M. Alhabeb, Z. Ling, K. A. Mahmoud, and Y. Gogotsi, “Charge- and Size-Selective Ion Sieving Through Ti₃C₂Tₓ MXene Membranes,” The Journal of Physical Chemistry Letters, vol. 6, no. 20, pp. 4026-4031, 2015, doi: 10.1021/acs.jpclett.5b01895.

M. Han et al., “Beyond Ti₃C₂Tₓ: MXenes for Electromagnetic Interference Shielding,” ACS Nano, vol. 14, no. 4, pp. 5008-5016, Apr. 28 2020, doi: 10.1021/acsnano.0c01312.

Y. Dong et al., “Saturable Absorption in 2D Ti3 C2 MXene Thin Films for Passive Photonic Diodes,” Adv Mater, vol. 30, no. 10, March 2018, doi: 10.1002/adma.201705714.

E. Bontempi et al., “Analysis of crystalline phases in airborne particulate matter by two-dimensional X-ray diffraction (XRD2),” J Environ Monit, vol. 10, no. 1, pp. 82-8, Jan. 2008, doi: 10.1039/b715517d.

A. B. Rodriguez-Navarro, “XRD2DScan: new software for polycrystalline materials characterization using two-dimensional X-ray diffraction,” Journal of Applied Crystallography, vol. 39, no. 6, pp. 905-909, 2006, doi: 10.1107/s0021889806042488.

G. Langelaan and S. Saimoto, “Thermal expansion measurement of pure aluminum using a very low thermal expansion heating stage for x-ray diffraction experiments,” Review of Scientific Instruments, vol. 70, no. 8, pp. 3413-3417, 1999, doi: 10.1063/1.1149928.

S. E. Shin, Y. J. Ko, and D. H. Bae, “Mechanical and thermal properties of nanocarbon-reinforced aluminum matrix composites at elevated temperatures,” Composites Part B: Engineering, vol. 106, pp. 66-73, 2016, doi: 10.1016/j.compositesb.2016.09.017.

X. Zhou, Y. Guo, D. Wang, and Q. Xu, “Nano friction and adhesion properties on Ti₃C₂ and Nb₂C MXene studied by AFM,” Tribology International, vol. 153, p. 106646, 2020, doi: 10.1016/j.triboint.2020.106646.

M. Dhanashekar, P. Loganathan, S. Ayyanar, S. R. Mohan, and T. Sathish, “Mechanical and wear behaviour of AA6061/SiC composites fabricated by powder metallurgy method,” Materials Today: Proceedings, vol. 21, pp. 1008-1012, 2020, doi: 10.1016/j.matpr.2019.10.052.

B. Siddharthan, R. Rajiev, S. Saravanan, and T. K. Naveen, “Effect of Silicon Carbide in Mechanical Properties of Aluminium Alloy Based Metal Matrix Composites,” presented at the TOP Conf. Series: Materials Science and Engineering, 2020, 012040.

K. Kaviyarasan, S. Thiyagu, V. Shabari, R. Saileswaran, S. Siva sankaran, and T. Sivanesan, “Investigation on mechanical properties of aluminium alloy A356 by reinforcing with TiB₂ & WC composites,” presented at the TOP Conf. Series: Materials Science and Engineering, 2021, 012110.

S. E. Shin, H. J. Choi, J. H. Shin, and D. H. Bae, “Strengthening behavior of few-layered graphene/aluminum composites,” Carbon, vol. 82, pp. 143-151, 2015, doi: 10.1016/j.carbon.2014.10.044.

W. Zhou, Y. Fan, X. Feng, K. Kikuchi, N. Nomura, and A. Kawasaki, “Creation of individual few-layer graphene incorporated in an aluminum matrix,” Composites Part A: Applied Science and Manufacturing, vol. 112, pp. 168-177, 2018, doi: 10.1016/j.compositesa.2018.06.008.

While embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A composite comprising:
a MXene having a general formula of
Mₙ₊₁XₙTₓ
wherein
M is a transition metal from the 3d to 5d blocks of groups 3-6 of the Periodic Table of Elements,
X is carbon or nitrogen,
Tₓ is a functional surface termination, and
n is an integer from 1 to 4, the integer identifying a number of atomic layers of M interleaved by X; and
a post-transition metal selected from aluminum, copper, zinc, gallium, germanium, arsenic, selenium, silver, cadmium, indium, tin, antimony, tellurium, gold, mercury, thallium, lead, bismuth, polonium, astatine, copernicium, nihonium, flerovium, moscovium, livermorium, tennessine, and a combination of two or more thereof;
wherein the post-transition metal is at least partially encapsulated by from 1 to 4 layers of the MXene.

2. The composite of claim 1, wherein M is Ti.

3. The composite of claim 1, wherein X is carbon.

4. The composite of claim 1, wherein Tₓ is selected from ═O, —F, —Cl, —OH, —Br, —I, —Se, —Te, —S, and a combination of two or more thereof.

5. The composite of claim 1, wherein n is 2.

6. The composite of claim 1, wherein M is Ti, X is carbon, and n is 2.

7. The composite of claim 1, wherein the post-transition metal is aluminum.

8. The composite of claim 1, wherein the post-transition metal is completely encapsulated by from 1 to 4 layers of the MXene.

9. The composite of claim 6, wherein the post-transition metal is completely encapsulated by from 1 to 4 layers of the MXene.

10. The composite of claim 9, wherein the post-transition metal is aluminum.

11. A method of making the composite of claim 1, the method comprising:
dispersing the post-transition metal in an organic carrier, thereby forming a first dispersion;
dispersing the MXene in an aqueous carrier, thereby forming a second dispersion;
mixing the first dispersion and the second dispersion, thereby forming a liquid phase and a solid precipitate comprising the composite; and
collecting the solid precipitate, thereby forming the composite.

12. The method of claim 11, further comprising milling the post-transition metal in the organic carrier prior to mixing the first dispersion and the second dispersion.

13. The method of claim 11, wherein the organic carrier comprises at least one alcohol.

14. The method of claim 13, wherein the at least one alcohol comprises ethanol.

15. The method of claim 11, wherein the aqueous carrier is distilled water.

16. The method of claim 11, wherein the mixing comprises:
adding the first dispersion to the second dispersion;
stirring the mixed first dispersion and second dispersion for from 5 minutes to 15 minutes; and
allowing the solid precipitate to settle for from 30 seconds to 2 minutes.

17. The method of claim 11, wherein the collecting comprises:
at least partially separating the liquid phase from the solid precipitate.

18. The method of claim 17, wherein the at least partially separating comprises at least one of decanting, drying, filtering, evaporating, freeze-drying, sedimentation, crystallization, evaporating, or a combination of two or more thereof.

19. The method of claim 17, wherein the at least partially separating comprises removing the liquid phase such that the solid precipitate comprises no more than 100 micrograms of the liquid phase per 1 gram of the solid precipitate.

20. The method of claim 11, wherein the composite has a Vickers microhardness from 100 HV to 250 HV.

21. The method of claim 11, wherein M is Ti, X is carbon, and n is 2.

22. The method of claim 21, wherein the post-transition metal is aluminum.

23. A composite comprising:
a MXene having a general formula of
Mₙ₊₁XₙTₓ
wherein
M is a transition metal from the 3d to 5d blocks of groups 3-6 of the Periodic Table of Elements,
X is carbon or nitrogen,
Tₓ is a functional surface termination, and
n is an integer from 1 to 4, the integer identifying a number of atomic layers of M interleaved by X; and
a bulk ceramic selected from the group consisting of a carbide of titanium, a carbide of zirconium, a carbide of hafnium, a carbide of silicon, a carbide of tantalum, a carbide of niobium, a carbide of tungsten, a diboride of titanium, a diboride of zirconium, a diboride of hafnium, a diboride of tantalum, a diboride of niobium, an oxide of aluminum, an oxide of manganese, an oxide of tin, and a combination of two or more thereof;
wherein the bulk ceramic is at least partially encapsulated by from 1 to 4 layers of the MXene.
